(19) United States
(12) Patent Application Publication
(10) Pub. No.: US 2026/0333293 A1
(43) Pub. Date: Oct. 22, 2026

(54) Communication Method and Related Device

(71) Applicant: HUAWEI TECHNOLOGIES CO., LTD., Shenzhen (CN)

(72) Inventors: Mengyuan Li, Hangzhou (CN); Jian Wang, Hangzhou (CN); Rong Li, Shanghai (CN); Xiaoyan Bi, Shanghai (CN); Jianglei Ma, Ottawa (CA)

(73) Assignee: HUAWEI TECHNOLOGIES CO., LTD., Shenzhen (CN)

(21) Appl. No.: 19/699,691

(22) Filed: Jun. 5, 2026

Related U.S. Application Data
(63) Continuation of application No. PCT/CN2024/119360, filed on Sep. 18, 2024.

(30) Foreign Application Priority Data
Dec. 8, 2023 (CN) 202311690963.4

(51) Int. Cl. H04W 64/00; H04L 1/00

(52) U.S. Cl. CPC H04W 64/006; H04L 1/0003; H04L 1/0009

(57) ABSTRACT

A communication method includes a first communication apparatus on a terminal side that generates first information indicating a mapping relationship between a location point in a first area and modulation and coding scheme (MCS) information. An execution process of constructing an MCS map (the first information) is transferred to an apparatus on the terminal side, so that computational power of a terminal side device is used.

### CROSS-REFERENCE TO RELATED APPLICATIONS

This is a continuation of International Patent Application No. PCT/CN2024/119360 filed on Sep. 18, 2024, which claims priority to Chinese Patent Application No. 202311690963.4 filed on Dec. 8, 2023, all of which are hereby incorporated by reference in their entireties.

### TECHNICAL FIELD

This application relates to the communication field, and in particular, to a communication method and a related device.

### BACKGROUND

Wireless communication may be transmission communication performed between two or more communication nodes without propagation via a conductor or a cable. The communication nodes typically include a network device and a terminal device.

A radio map can reflect parameter values of at respective location points within a wireless network. Common radio maps include a channel gain map, a received signal strength map, a power spectral density map, a modulation and coding scheme (MCS) map, and the like. Radio maps are widely used in wireless communication and networking, including network planning, interference control, power control, resource allocation, handover management, multi-hop routing, dynamic spectrum access, and cognitive radio network tasks.

The MCS map is defined as a mapping relationship between each location point in a network and an ordering of MCS indexes, and the ordering of MCS indexes reflects priorities of different MCS indexes. During MCS map construction, the MCS map may be constructed on a network side in a centralized manner. However, there may further be surplus computational capabilities in a communication network. Therefore, how to utilize these computational capabilities is an urgent technical problem to be resolved.

### SUMMARY

This application provides a communication method and a related device, to transfer an execution process of constructing an MCS map (first information) to an apparatus on a terminal side, so that computational power of a terminal side device is used, thereby reducing computational power overheads of a network device.

A first aspect of this application provides a communication method. The method is performed by a first communication apparatus. The first communication apparatus may be a communication device (such as a terminal device), or the first communication apparatus may be some components (such as a processor, a chip, or a chip system) in a communication device, or the first communication apparatus may be a logical module or software that can implement all or some functions of a communication device. In the method, a first communication apparatus on a terminal side generates first information indicating a mapping relationship between a location point in a first area and MCS information. An execution process of constructing an MCS map (the first information) is transferred to an apparatus on the terminal side, so that computational power of a terminal side device is used, thereby reducing computational power overheads of a network device.

It should be understood that the location point may be a location point in a physical sense, or may be a logical or virtual location point, for example, an area set.

It should be understood that the MCS information may indicate a sorting manner of a plurality of MCS indexes, a sequence number of each MCS index describes a ranking of the corresponding MCS index in the sorting manner, and different sequence numbers correspond to different priorities.

In a possible implementation, the first communication apparatus may be a terminal side apparatus in the first area. The first area may be a sub-area obtained by dividing an area served by a network device (for example, a second communication apparatus described in embodiments of this application).

In a possible implementation, the first communication apparatus may generate the first information based on second information, where the second information indicates information about the location point in the first area.

For example, the information about the location point may include but is not limited to location information of the location point.

For example, the second information may further indicate location information of a network device in the first area, or network environment information of a network device in the first area.

In a possible implementation, the first communication apparatus may send the first information to a second communication apparatus, and the second communication apparatus is an apparatus on a network side.

In a possible implementation, the information about the location point is obtained based on information collected at the location point by the first communication apparatus; or the information about the location point is obtained based on information collected at the location point by at least one user side apparatus in the first area.

In a possible implementation, the first communication apparatus may further obtain a normalization parameter, where the normalization parameter is determined based on the information collected at the location point in the first area; and normalize the information about the location point based on the normalization parameter.

In a possible implementation, the first communication apparatus may further obtain a normalization parameter, where the normalization parameter is determined based on information collected at location points in a plurality of areas including the first area; and normalize the information about the location point based on the normalization parameter.

In a possible implementation, before the sending the first information, the method further includes receiving first indication information from a third communication apparatus, where the first indication information indicates a request for obtaining the mapping relationship between the location point in the first area and the MCS information, and the third communication apparatus is an apparatus on the terminal side; and the sending the first information includes sending the first information to the third communication apparatus.

In a possible implementation, before the sending the first information, the method further includes receiving second indication information from the second communication apparatus, where the second indication information indicates to send the mapping relationship between the location point in the first area and the MCS information to the third communication apparatus, and the third communication apparatus is an apparatus on the terminal side; and the sending the first information includes sending the first information to the third communication apparatus.

In a possible implementation, after the sending the first information, the method further includes receiving third information, where the third information is obtained by aggregating a plurality of pieces of information including the first information, and the plurality of pieces of information include information indicating a mapping relationship between a location point in a second area and MCS information.

In a possible implementation, each of the plurality of pieces of information is a machine learning model, and the third information is a machine learning model obtained by fusing model processing capabilities of the plurality of pieces of information.

According to the foregoing method, MCS maps of different areas are generated by terminal side apparatuses in the areas, and processes of generating the MCS maps of the different areas are independent of each other (or most of the processes are independent, except that there is specific coupling in terms of aggregation by a network side apparatus and determining of a normalization parameter), so that the different areas are independently calculated and more personalized. This implementation has a better effect especially when the MCS map is a machine learning model. This is because model training performed based on a training sample constructed based on information in a small area converges more easily than a model training process performed based on a training sample constructed based on information in a large area. In addition, compared with model training performed based on the training sample constructed based on the information in the large area, a manner of model training and model capability fusion based on the small area makes a fused model have a better processing capability for each area, thereby ensuring performance of the MCS map.

In a possible implementation, the method further includes performing model training on the third information based on a training sample obtained by using fourth information, to obtain fifth information, where the fourth information is updated information about the location point in the first area; and sending the fifth information.

The “updated information about the location point in the first area” herein may be understood as that the location point in the first area is updated, and then the information about the location point is also updated, or the location point in the first area does not change (for example, a location does not change), but the information about the location point is updated.

It should be understood that the updated information about the location point in the first area may be completely different from or partially the same as and partially different from information about the location point in the first area before the update. This is not limited herein.

A second aspect of this application provides a communication method. The method is performed by a second communication apparatus. The second communication apparatus may be a communication device (such as a network device), or the second communication apparatus may be some components (such as a processor, a chip, or a chip system) in a communication device, or the second communication apparatus may be a logical module or software that can implement all or some functions of a communication device. In the method, a second communication apparatus may receive first information, where the first information is generated by a first communication apparatus, the first communication apparatus is an apparatus on a terminal side, and the first information indicates a mapping relationship between a location point in a first area and MCS information.

In a possible implementation, the first communication apparatus communicates with a second communication apparatus, the second communication apparatus is an apparatus on a network side, the first area is a part of a target area, and the target area is an area served by the second communication apparatus.

In a possible implementation, the MCS information indicates an ordering manner of MCS indexes.

In a possible implementation, after the receiving the first information, the method further includes receiving first indication information from a third communication apparatus, where the first indication information indicates a request for obtaining the mapping relationship between the location point in the first area and the MCS information, and the third communication apparatus is an apparatus on the terminal side; and sending the first information to the third communication apparatus.

In a possible implementation, the method further includes receiving first indication information from a third communication apparatus, where the first indication information indicates a request for obtaining the mapping relationship between the location point in the first area and the MCS information, and the third communication apparatus is an apparatus on the terminal side; and sending second indication information to a terminal side apparatus that stores the MCS information of the first area, where the second indication information indicates to send the mapping relationship between the location point in the first area and the MCS information to the third communication apparatus.

In a possible implementation, the method further includes sending third information, where the third information is an aggregation result of a plurality of pieces of information including the first information, and the plurality of pieces of information include information indicating a mapping relationship between a location point in a second area and MCS information.

In a possible implementation, each of the plurality of pieces of information is a machine learning model.

The third information is a machine learning model obtained by fusing model processing capabilities of the plurality of pieces of information.

In a possible implementation, after the sending the third information, the method further includes receiving fourth information, where the fourth information is obtained by performing model training on the third information.

In a possible implementation, the sending the third information includes broadcasting the third information to a terminal side apparatus in the first area based on the third information meeting a model training target.

A third aspect of this application provides a communication method. The method is performed by a third communication apparatus. The third communication apparatus may be a communication device (such as a terminal device), or the third communication apparatus may be some components (such as a processor, a chip, or a chip system) in a communication device, or the third communication apparatus may be a logical module or software that can implement all or some functions of a communication device. In the method, the third communication apparatus sends first indication information, where the first indication information indicates a request for obtaining a mapping relationship between a location point in a first area and MCS information; and receives first information, where the first information is generated by a first communication apparatus, the first communication apparatus is an apparatus on a terminal side, and the first information indicates the mapping relationship between the location point in the first area and the MCS information.

In a possible implementation, the first communication apparatus communicates with a second communication apparatus, the second communication apparatus is an apparatus on a network side, the first area is a part of a target area, and the target area is an area served by the second communication apparatus.

In a possible implementation, the sending the first indication information includes sending the first indication information to the second communication apparatus, where the second communication apparatus is an apparatus on the network side.

The receiving the first information includes receiving the first information sent by a terminal side apparatus in the first area.

In a possible implementation, the sending the first indication information includes sending the first indication information to a terminal side apparatus in the first area.

The receiving the first information includes receiving the first information sent by the terminal side apparatus in the first area.

In a possible implementation, the sending the first indication information includes sending the first indication information to the second communication apparatus, where the second communication apparatus is an apparatus on the network side.

The receiving the first information includes receiving the first information sent by the second communication apparatus.

A fourth aspect of this application provides a communication method. The method is performed by a third communication apparatus. The third communication apparatus may be a communication device (such as a terminal device), or the third communication apparatus may be some components (such as a processor, a chip, or a chip system) in a communication device, or the third communication apparatus may be a logical module or software that can implement all or some functions of a communication device. In the method, a third communication apparatus receives third information, where the third information is obtained by aggregating a plurality of pieces of information including first information, the first information is generated by a first communication apparatus, the first communication apparatus is an apparatus on a terminal side, and the first information indicates a mapping relationship between a location point in a first area and MCS information.

In a possible implementation, the first communication apparatus communicates with a second communication apparatus, the second communication apparatus is an apparatus on a network side, the first area is a part of a target area, and the target area is an area served by the second communication apparatus.

A fifth aspect of this application provides a communication apparatus. The apparatus is a first communication apparatus, and the apparatus includes a transceiver unit and a processing unit. The processing unit is configured to generate first information, where the first communication apparatus is an apparatus on a terminal side, and the first information indicates a mapping relationship between a location point in a first area and MCS information. The transceiver unit is configured to send the first information.

In the fifth aspect of this application, the component modules of the communication apparatus may be further configured to perform the steps performed in the possible implementations of the first aspect, and achieve corresponding technical effects. For details, refer to the first aspect. Details are not described herein again.

A sixth aspect of this application provides a communication apparatus. The apparatus is a second communication apparatus, and the apparatus includes a transceiver unit and a processing unit. The transceiver unit is configured to receive first information, where the first information is generated by a first communication apparatus based on second information, the first communication apparatus is an apparatus on a terminal side, and the first information indicates a mapping relationship between a location point in a first area and MCS information.

In the sixth aspect of this application, the component modules of the communication apparatus may be further configured to perform the steps performed in the possible implementations of the second aspect, and achieve corresponding technical effects. For details, refer to the second aspect. Details are not described herein again.

A seventh aspect of this application provides a communication apparatus. The apparatus is a third communication apparatus, and the apparatus includes a transceiver unit and a processing unit. The transceiver unit is configured to send first indication information, where the first indication information indicates a request for obtaining a mapping relationship between a location point in a first area and MCS information; and receive first information, where the first information is generated by a first communication apparatus, the first communication apparatus is an apparatus on a terminal side, and the first information indicates the mapping relationship between the location point in the first area and the MCS information.

In the seventh aspect of this application, the component modules of the communication apparatus may be further configured to perform the steps performed in the possible implementations of the third aspect and the fourth aspect, and achieve corresponding technical effects. For details, refer to the third aspect and the fourth aspect. Details are not described herein again.

An eighth aspect of this application provides a communication apparatus, including at least one processor. The at least one processor is coupled to a memory, the memory is configured to store a program or instructions, and the at least one processor is configured to execute the program or the instructions, to enable the apparatus to implement the method according to any possible implementation in any one of the first aspect to the fourth aspect.

A ninth aspect of this application provides a communication apparatus, including at least one logic circuit and an input/output interface. The logic circuit is configured to perform the method according to any possible implementation in any one of the first aspect to the fourth aspect.

A tenth aspect of this application provides a communication system. The communication system includes the first communication apparatus and the second communication apparatus, or the first communication apparatus and the third communication apparatus, or the second communication apparatus and the third communication apparatus.

An eleventh aspect of this application provides a computer-readable storage medium. The storage medium is configured to store one or more computer-executable instructions. When the computer-executable instructions are executed by a processor, the processor performs the method according to any possible implementation in any one of the first aspect to the fourth aspect.

A twelfth aspect of this application provides a computer program product (a computer program). When a computer program in the computer program product is executed by a processor, the processor performs the method according to any possible implementation of any one of the first aspect to the fourth aspect.

A thirteenth aspect of this application provides a chip system. The chip system includes at least one processor, configured to support a communication apparatus in implementing the method according to any possible implementation of any one of the first aspect to the fourth aspect.

In a possible design, the chip system may further include a memory. The memory is configured to store program instructions and data that are necessary for the communication apparatus. The chip system may include a chip, or may include a chip and another discrete component. In an embodiment, the chip system further includes an interface circuit, and the interface circuit provides program instructions and/or data for the at least one processor.

### BRIEF DESCRIPTION OF DRAWINGS

FIG. 1A to FIG. 1C are diagrams of communication systems according to this application;

FIG. 1D, FIG. 1E, and FIG. 2A to FIG. 2E are diagrams of processing processes according to this application;

FIG. 3 is a diagram of interaction in a communication method according to this application;

FIG. 4 to FIG. 12 are diagrams of interaction in communication methods according to this application; and

FIG. 13 to FIG. 17 are diagrams of communication apparatuses according to this application.

### DESCRIPTION OF EMBODIMENTS

First, some terms in embodiments of this application are explained and described, to facilitate understanding of a person skilled in the art.

(1) Terminal device: may be a wireless terminal device that can receive scheduling and indication information of a network device. The wireless terminal device may be a device that provides voice and/or data connectivity for a user, a handheld device with a wireless connection function, or another processing device connected to a wireless modem.

The terminal device may communicate with one or more core networks or the Internet through a radio access network (RAN). The terminal device may be a mobile terminal device such as a mobile telephone (a “cellular” phone or a mobile phone), a computer, and a data card. For example, the terminal device may be a portable, pocket-sized, handheld, computer built-in, or vehicle-mounted mobile apparatus that exchanges a voice and/or data with the radio access network. For example, the terminal device may be a device such as a personal communication service (PCS) phone, a cordless phone, a Session Initiation Protocol (SIP) phone, a wireless local loop (WLL) station, a personal digital assistant (PDA), a tablet computer (Pad), or a computer having wireless sending and receiving functions. The wireless terminal device may also be referred to as a system, a subscriber unit, a subscriber station (SS), a mobile station (MS), a remote station, an access point (AP), a remote terminal device (remote terminal), an access terminal device (access terminal), a user terminal device (user terminal), a user agent, customer premises equipment (CPE), a terminal, a terminal device (UE), a mobile terminal (MT), or the like.

By way of example and not limitation, in embodiments of this application, the terminal device may alternatively be a wearable device. The wearable device may also be referred to as a wearable intelligent device, an intelligent wearable device, or the like, and is a general term of wearable devices that are intelligently designed and developed for daily wear by using a wearable technology, for example, glasses, gloves, watches, clothes, and shoes. The wearable device is a portable device that is directly worn on a body or integrated into clothes or an accessory of a user. The wearable device is not only a hardware device, but also implements a powerful function through software support, data exchange, and cloud interaction. Generalized wearable intelligent devices include full-featured and large-sized devices that can implement complete or partial functions without depending on a smartphone, for example, a smartwatch or smart glasses, and devices that focus on only one type of application function and need to work with another device such as a smartphone, for example, various smart bands, smart helmets, or smart jewelry for monitoring physical signs.

The terminal may alternatively be an uncrewed aerial vehicle, a robot, a terminal in device-to-device (D2D) communication, a terminal in vehicle-to-everything (V2X), a virtual reality (VR) terminal device, an augmented reality (AR) terminal device, a wireless terminal in industrial control, a wireless terminal in self-driving, a wireless terminal in telemedicine (remote medical), a wireless terminal in a smart grid, a wireless terminal in transportation safety, a wireless terminal in a smart city, a wireless terminal in a smart home, or the like.

In addition, the terminal device may alternatively be a terminal device in a communication system (for example, a 6th generation (6G) communication system) evolved after a 5th generation (5G) communication system, a terminal device in a future evolved public land mobile network (PLMN), or the like. For example, a 6G network may further extend a form and a function of a 5G communication terminal, and a 6G terminal includes but is not limited to a vehicle, a cellular network terminal (integrating a function of a satellite terminal), an uncrewed aerial vehicle, or an internet of things (IoT) device.

In embodiments of this application, the terminal device may further obtain an artificial intelligence (AI) service provided by a network device. In an embodiment, the terminal device may further have an AI processing capability.

(2) Network device: may be a device in a wireless network. For example, the network device may be a RAN node (or device) through which a terminal device accesses the wireless network, and may also be referred to as a base station. Currently, some examples of the RAN device are a base station, an evolved NodeB (eNodeB or eNB), a base station gNB (gNodeB) in a 5G communication system, a transmission reception point (TRP), a radio network controller (RNC), a NodeB (NB), a home base station (for example, a home evolved NodeB or a home NodeB (HNB)), a baseband unit (BBU), a Wi-Fi AP, and the like. In addition, in a network structure, a network device may include a central unit (CU) node, a distributed unit (DU) node, or a RAN device including a CU node and a DU node.

In an embodiment, the RAN node may alternatively be a macro base station, a micro base station, an indoor base station, a relay node, or a donor node, or may be a radio controller in a cloud radio access network (CRAN) scenario. The RAN node may alternatively be a server, a wearable device, a vehicle, a vehicle-mounted device, or the like. For example, an access network device in a V2X technology may be a road side unit (RSU).

In another possible scenario, a plurality of RAN nodes coordinate to assist the terminal in implementing radio access, and different RAN nodes respectively implement some functions of a base station. For example, the RAN node may be a CU, a DU, a CU-control plane (CP), a CU-user plane (UP), a radio unit (RU), or the like. The CU and the DU may be separately arranged, or may be included in a same network element, for example, a BBU. The RU may be included in a radio frequency device or a radio frequency unit, for example, included in a remote radio unit (RRU), an active antenna unit (AAU), or a remote radio head (RRH).

In different systems, the CU (or the CU-CP and the CU-UP), the DU, or the RU may alternatively have different names, but a person skilled in the art may understand meanings thereof. For example, in an open access network (open RAN (O-RAN or ORAN)) system, the CU may also be referred to as an open CU (O-CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any unit in the CU (or the CU-CP or the CU-UP), the DU, and the RU in this application may be implemented by using a software module, a hardware module, or a combination of the software module and the hardware module.

Communication between an access network device and a terminal device complies with a specific protocol layer structure. Protocol layers may include a control plane protocol layer and a user plane protocol layer. The control plane protocol layer may include at least one of a radio resource control (RRC) layer, a Packet Data Convergence Protocol (PDCP) layer, a radio link control (RLC) layer, a media access control (MAC) layer, a physical layer (PHY), or the like. The user plane protocol layer may include at least one of a Service Data Adaptation Protocol (SDAP) layer, a PDCP layer, an RLC layer, a MAC layer, a physical layer, or the like.

For a correspondence between network elements in the ORAN system and protocol layer functions that can be implemented by the network elements, refer to Table 1 below.

TABLE 1

| ORAN network element | 3GPP protocol layer function |
|---|---|
| O-CU-CP | RRC + PDCP-control plane (PDCP-C) |
| O-CU-UP | SDAP + PDCP-user plane (PDCP-U) |
| O-DU | RLC + MAC + PHY-high |
| O-RU | PHY-low |

The network device may be another apparatus that provides a wireless communication function for an apparatus on a terminal side. Neither of a specific technology and a specific device form used by the network device is limited in embodiments of this application. For ease of description, this is not limited in embodiments of this application.

The network device may further include a core network device. For example, the core network device includes a network element such as a mobility management entity (MME), a home subscriber server (HSS), a serving gateway (S-GW), a policy and charging rules function (PCRF), or a public data network (PDN) gateway (P-GW) in a 4th generation (4G) network; or an access and mobility management function (AMF), a user plane function (UPF), or a session management function (SMF) in a 5G network. In addition, the core network device may further include another core network device in a 5G network and a next-generation network of the 5G network.

In embodiments of this application, the network device may alternatively be a network node having an AI capability, and may provide an AI service for a terminal or another network device, for example, may be an AI node, a computational power node, a RAN node having an AI capability, or a core network element having an AI capability on a network side (an access network or a core network).

In embodiments of this application, an apparatus configured to implement a function of a network device may be a network device, or may be an apparatus that can support the network device in implementing the function, for example, a chip system. The apparatus may be installed in the network device. In the technical solutions provided in embodiments of this application, the technical solutions provided in embodiments of this application are described by using an example in which the apparatus configured to implement a function of a network device is a network device.

(3) Configuration and preconfiguration: In this application, both the configuration and the preconfiguration are used. The configuration means that a network device/server sends configuration information of some parameters or values of parameters to a terminal by using a message or signaling, so that the terminal determines a parameter for communication or a resource for transmission based on the values or the information. Similar to the configuration, the preconfiguration may be parameter information or a parameter value negotiated by a network device/server with a terminal device in advance, or may be parameter information or a parameter value that is to be used by a base station/network device or a terminal device and that is specified in a standard protocol, or may be parameter information or a parameter value pre-stored in a base station/server or a terminal device. This is not limited in this application.

Further, the values and parameters may be changed or updated.

(4) Terms “system” and “network” in embodiments of this application may be used interchangeably. “A plurality of” means two or more than two. The term “and/or” describes an association relationship of associated objects, and indicates that three relationships may exist. For example, A and/or B may indicate the following three cases: Only A exists, both A and B exist, and only B exists. A and B may be singular or plural. The character “/” usually indicates an “or” relationship between the associated objects. “At least one of the following items (pieces)” or a similar expression thereof refers to any combination of these items, including a single item (piece) or any combination of a plurality of items (pieces). For example, “at least one of A, B, and C” includes A, B, C, AB, AC, BC, or ABC. In addition, unless otherwise specified, ordinal numbers such as “first” and “second” in embodiments of this application are used to distinguish between a plurality of objects, and are not used to limit a sequence, a time sequence, priorities, or importance of the plurality of objects.

(5) “Sending” and “receiving” in embodiments of this application represent signal transfer directions. For example, “sending information to XX” may be understood as that a destination end of the information is XX, and may include direct sending through an air interface, or include indirect sending through an air interface by another unit or module. “Receiving information from YY” may be understood as that a source end of the information is YY, and may include direct receiving from YY through an air interface, or may include indirect receiving from YY via another unit or module through an air interface. “Sending” may alternatively be understood as “outputting” of a chip interface, and “receiving” may alternatively be understood as “inputting” of the chip interface.

In other words, sending and receiving may be performed between devices, for example, between a network device and a terminal device, or may be performed within a device. For example, sending or receiving is performed between components, modules, chips, software modules, or hardware modules in a device by using a bus, a cable, or an interface.

It may be understood that necessary processing, for example, encoding and modulation, may be performed on information between a source end and a destination end of information sending, but the destination end may understand valid information from the source end. Similar expressions in this application may be understood similarly. Details are not described again.

(6) In embodiments of this application, “indication” may include a direct indication and an indirect indication, or may include an explicit indication and an implicit indication. Information indicated by a piece of information (for example, the following indication information) is referred to as to-be-indicated information. In a specific implementation process, the to-be-indicated information is indicated in a plurality of manners. By way of example and not limitation, the to-be-indicated information may be directly indicated, for example, the to-be-indicated information or an index of the to-be-indicated information is indicated. Alternatively, the to-be-indicated information may be indirectly indicated by indicating other information. There is an association relationship between the other information and the to-be-indicated information. Alternatively, only a part of the to-be-indicated information may be indicated, and the remaining part of the to-be-indicated information is known or pre-agreed on. For example, specific information may be indicated by using an arrangement sequence of pieces of information that are pre-agreed on (for example, predefined in a protocol), to reduce indication overheads to some extent. A specific indication manner is not limited in this application. It may be understood that, for a sender of the indication information, the indication information may indicate to-be-indicated information, and for a receiver of the indication information, the indication information may be for determining the to-be-indicated information.

(7) Modulation and coding scheme table: In this specification, a modulation and coding scheme may be briefly referred to as an MCS. Therefore, in this specification, the modulation and coding scheme table may be briefly referred to as an MCS table. However, the modulation and coding scheme is not limited in this specification, and may be translated in another manner. The MCS table includes at least one of a modulation scheme, a coding rate, spectral efficiency, and the like. One MCS table may include at least one type of modulation and coding scheme information, and each type of modulation and coding scheme information has a corresponding index (namely, a MCS index), and corresponds to at least one of a modulation scheme, a coding rate, and spectral efficiency. Similarly, because the modulation and coding scheme is briefly referred to as the MCS in this specification, the modulation and coding scheme information may also be briefly referred to as MCS information.

In this application, unless otherwise specified, for same or similar parts of the embodiments, refer to each other. In embodiments of this application and methods/designs/implementations in embodiments, unless otherwise specified or unless a logic conflict occurs, terms and/or descriptions between different embodiments and between methods/designs/implementations in embodiments are consistent and may be mutually referenced, and technical features in different embodiments and methods/designs/implementations in embodiments may be combined to form a new embodiment, method, or implementation based on an internal logic relationship thereof. The following implementations of this application are not intended to limit the protection scope of this application.

This application may be applied to a Long-Term Evolution (LTE) system, a new radio (NR) system, or a communication system (for example, 6G) evolved after 5G. The communication system includes at least one network device and/or at least one terminal device.

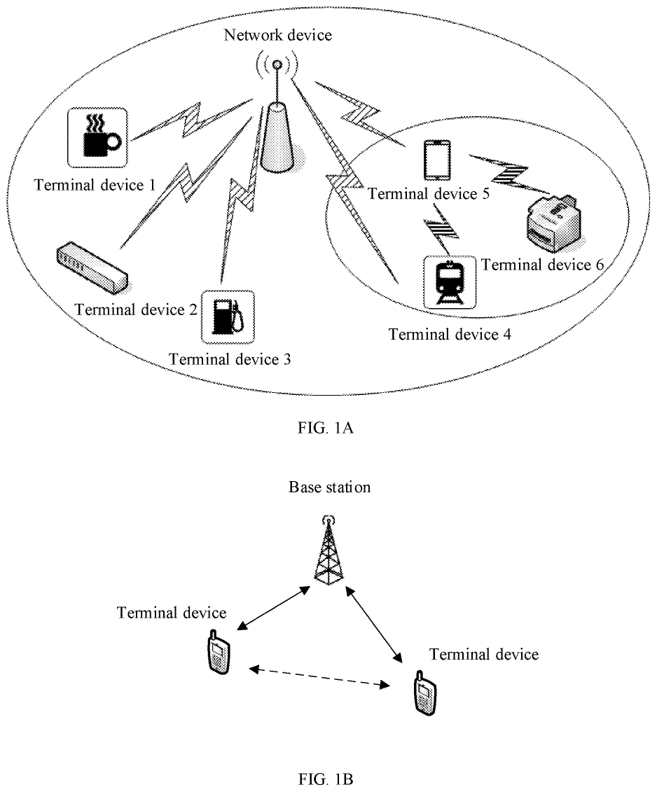

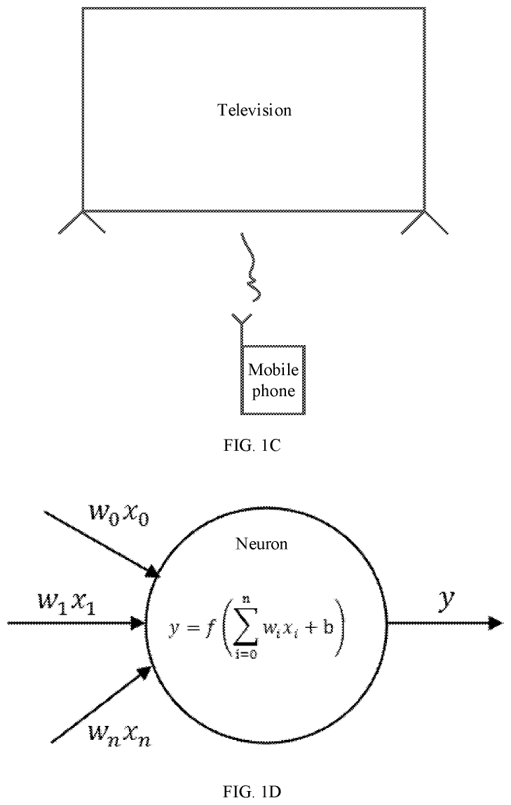

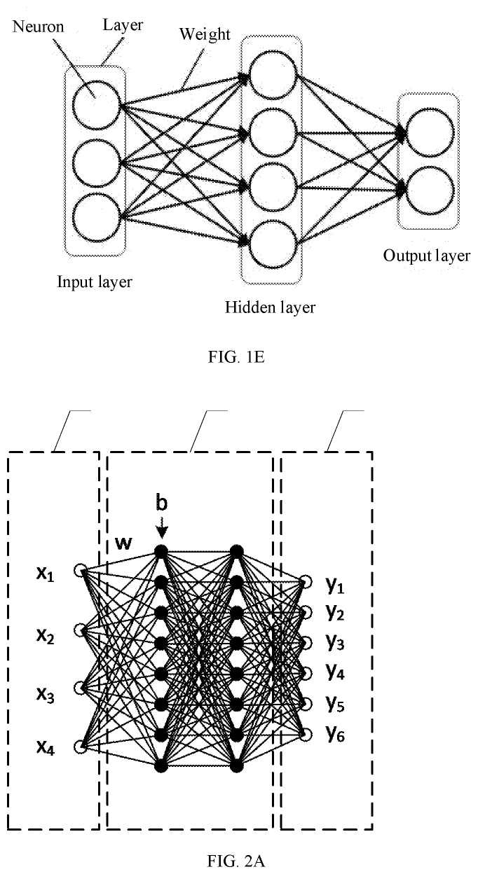

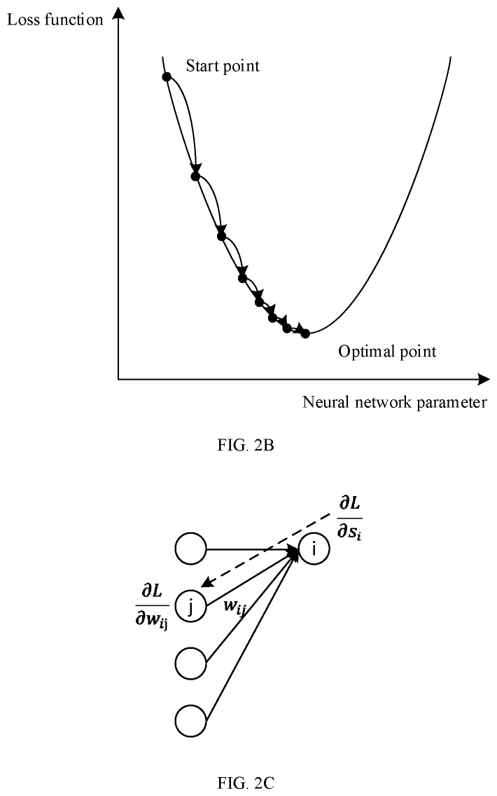

FIG. 1A is a diagram of a communication system according to this application. FIG. 1A shows one network device and six terminal devices as an example. The six terminal devices are respectively a terminal device 1, a terminal device 2, a terminal device 3, a terminal device 4, a terminal device 5, and a terminal device 6. In the example shown in FIG. 1A, an example in which the terminal device 1 is a smart teacup, the terminal device 2 is a smart air conditioner, the terminal device 3 is a smart fuel dispenser, the terminal device 4 is a vehicle, the terminal device 5 is a mobile phone, and the terminal device 6 is a printer is used for description.

As shown in FIG. 1A, an AI configuration information sending entity may be an apparatus on a network side. AI configuration information receiving entities may be the terminal device 1 to the terminal device 6. In this case, the network device and the terminal device 1 to the terminal device 6 form a communication system. In the communication system, the terminal device 1 to the terminal device 6 may send data to the network device, and the network device needs to receive the data sent by the terminal device 1 to the terminal device 6. In addition, the network device may send configuration information to the terminal device 1 to the terminal device 6.

For example, in FIG. 1A, the terminal device 4 to the terminal device 6 may also form a communication system. The terminal device 5 serves as an apparatus on a network side, that is, an AI configuration information sending entity. The terminal device 4 and the terminal device 6 serve as apparatuses on a terminal side, that is, AI configuration information receiving entities. For example, in an internet of vehicles system, the terminal device 5 separately sends AI configuration information to the terminal device 4 and the terminal device 6, and receives data sent by the terminal device 4 and the terminal device 6. Correspondingly, the terminal device 4 and the terminal device 6 receive the AI configuration information sent by the terminal device 5, and send the data to the terminal device 5.

The communication system shown in FIG. 1A is used as an example. In addition to a communication-related service, an AI-related service may further be performed between different devices (including between network devices, between a network device and a terminal device, and/or between terminal devices).

As shown in FIG. 1B, an example in which a network device is a base station is used. A communication-related service and an AI-related service may be performed between the base station and one or more terminal devices, and the communication-related service and the AI-related service may also be performed between different terminal devices.

As shown in FIG. 1C, an example in which terminal devices include a television and a mobile phone is used. A communication-related service and an AI-related service may also be performed between the television and the mobile phone.

The technical solutions provided in this application may be applied to a wireless communication system (for example, the system shown in FIG. 1A, FIG. 1B, or FIG. 1C). For example, an AI network element may be introduced into the communication system provided in this application to implement some or all AI-related operations. The AI network element may also be referred to as an AI node, an AI device, an AI entity, an AI module, an AI model, an AI unit, or the like. The AI network element may be built in a network element in the communication system. For example, the AI network element may be an AI module built in an access network device, a core network device, a cloud server, or an operation, administration and maintenance (OAM), to implement an AI-related function. The OAM may serve as a network manager of a core network device and/or as a network manager of an access network device. Alternatively, the AI network element may be an independently disposed network element in the communication system. In an embodiment, a terminal or a chip built in a terminal may also include an AI entity, configured to implement an AI-related function.

The following briefly describes AI that may be used in this application.

The AI can enable machines to have human intelligence, for example, can enable the machines to use computer software and hardware to simulate some intelligent human behaviors. To implement the artificial intelligence, a machine learning method may be used. In the machine learning method, a machine obtains a model through learning (or training) by using training data. The model represents mapping from an input to an output. The model obtained through learning may be used for inference (or prediction). To be specific, the model may be used to predict an output corresponding to a given input. The output may also be referred to as an inference result (or a prediction result).

Machine learning may include supervised learning, unsupervised learning, and reinforcement learning. The unsupervised learning may also be referred to as non-supervised learning.

In terms of the supervised learning, based on collected sample values and sample labels, a mapping relationship between the sample values and the sample labels is learned by using a machine learning algorithm, and the learned mapping relationship is expressed by using an AI model. A process of training a machine learning model is a process of learning the mapping relationship. In the training process, a sample value is input into the model to obtain a predicted value of the model, and a model parameter is optimized by calculating an error between the predicted value of the model and a sample label (ideal value). After the mapping relationship is learned, a new sample label may be predicted by using the learned mapping. The mapping relationship learned through the supervised learning may include linear mapping or non-linear mapping. Learning tasks may be classified into a classification task and a regression task based on types of labels.

In terms of the unsupervised learning, an internal pattern of a sample is explored autonomously by using an algorithm based on a collected sample value. In a specific type of algorithm of the unsupervised learning, a sample is used as a supervised signal. In other words, a model learns a mapping relationship between samples. This is referred to as self-supervised learning. During training, a model parameter is optimized by calculating an error between a predicted value of the model and the sample. The self-supervised learning may be used for signal compression and decompression restoration. Common algorithms include an autoencoder, a generative adversarial network, and the like.

The reinforcement learning is different from the supervised learning, and is an algorithm that learns a problem-resolving policy by interacting with an environment. Different from the supervised learning and the unsupervised learning, the reinforcement learning does not have clear “correct” action label data. The algorithm needs to interact with the environment to obtain a reward signal fed back by the environment and then adjust a decision action to obtain a larger reward signal value. For example, in downlink power control, a reinforcement learning model adjusts a downlink transmit power of each user based on a total system throughput fed back by a wireless network, to expect to obtain a higher system throughput. An objective of the reinforcement learning is also to learn a mapping relationship between an environment status and a good (for example, an optimal) decision action. However, a label of “correct action” cannot be obtained in advance. Therefore, a network cannot be optimized by calculating an error between an action and the “correct action”. Reinforcement learning training is implemented through iterative interaction with the environment.

A neural network (NN) is a specific model in a machine learning technology. According to a universal approximation theorem, the neural network can theoretically approximate any continuous function, so that the neural network has a capability of learning any mapping. In a communication system, rich expertise is required to design a communication module. However, in a neural network-based deep learning communication system, an implicit pattern structure may be automatically discovered from a large quantity of data sets and a mapping relationship between data may be established, to obtain performance better than that of a modeling method.

The idea of the neural network is from a neuron structure of brain tissue. For example, each neuron performs a weighted summation operation on input values of the neuron, and outputs an operation result through an activation function.

FIG. 1D is a diagram of a neuron structure. It is assumed that inputs of the neuron are x=[x₀, x₁, . . . , xₙ], and weights corresponding to the inputs are w=[w, w₁, . . . , wₙ], where n is a positive integer, and wᵢ and xᵢ may be of various possible types such as a decimal, an integer (for example, 0, a positive integer, or a negative integer), or a complex number. wᵢ is used as a weight of xᵢ, and is used to perform weighting on xᵢ. A bias for performing weighted summation on input values based on the weights is, for example, b. The activation function may have a plurality of forms. Assuming that an activation function of a neuron is y=f(z)=max (0, z), an output of the neuron is

$$y = f ( {Σ}_{i = 0}^{i = n} {w}_{i} * {x}_{i} + b ) = max ( 0 , {Σ}_{i = 0}^{i = n} {w}_{i} * {x}_{i} + b ) .$$

For another example, if an activation function of a neuron is y=f(z)=z, an output of the neuron is

$$y = f ( {Σ}_{i = 0}^{i = n} {w}_{i} * {x}_{i} + b ) = {Σ}_{i = 0}^{i = n} {w}_{i} * {x}_{i} + b .$$

b may be of various possible types such as a decimal, an integer (for example, 0, a positive integer, or a negative integer), or a complex number. Activation functions of different neurons in the neural network may be the same or different.

In addition, the neural network usually includes a plurality of layers, and each layer may include one or more neurons. A depth and/or a width of the neural network are/is increased, so that an expression capability of the neural network can be improved, and more powerful information extraction and abstraction modeling capabilities can be provided for a complex system. The depth of the neural network may refer to a quantity of layers included in the neural network, and a quantity of neurons included in each layer may be referred to as a width of the layer. In an implementation, the neural network includes an input layer and an output layer. The input layer of the neural network performs neuron processing on received input information, and transfers a processing result to the output layer. The output layer obtains an output result of the neural network. In another implementation, the neural network includes an input layer, a hidden layer, and an output layer. The input layer of the neural network performs neuron processing on received input information, and transfers a processing result to an intermediate hidden layer. The hidden layer performs calculation on the received processing result to obtain a calculation result. The hidden layer transfers the calculation result to the output layer or a next adjacent hidden layer. Finally, the output layer obtains an output result of the neural network. One neural network may include one hidden layer, or include a plurality of hidden layers that are sequentially connected. This is not limited.

The neural network is, for example, a deep neural network (DNN). According to a network construction manner, the DNN may include a feedforward neural network (FNN), a convolutional neural network (CNN), and a recurrent neural network (RNN).

FIG. 1E is a diagram of an FNN network. A feature of the FNN network is that neurons at adjacent layers are completely connected in pairs. Due to this feature, the FNN usually needs a large amount of storage space, resulting in high computational complexity.

The CNN is a neural network dedicated to processing data of a similar grid structure. For example, both time series data (timeline discrete sampling) and image data (two-dimensional discrete sampling) may be considered as the data of the similar grid structure. The CNN performs a convolution operation by capturing partial information through a window with a fixed size, instead of performing an operation by using all input information at a time. This greatly reduces a calculation amount for a model parameter. In addition, based on different types of information captured through the window (for example, a person and an object in a same image are information of different types), different convolution kernel operations may be used for each window, so that the CNN can better extract a feature of input data.

The RNN is a DNN network using feedback time series information. Inputs of the RNN include a new input value at a current moment and an output value of the RNN at a previous moment. The RNN is suitable for obtaining a sequence feature having a time correlation, and is especially suitable for applications such as speech recognition and channel coding and decoding.

In the foregoing model training process of machine learning, a loss function may be defined. The loss function describes a gap or a difference between an output value of the model and an ideal target value. The loss function may be expressed in a plurality of forms, and a specific form of the loss function is not limited. The model training process may be considered as the following process. Some or all parameters of the model are adjusted, so that a value of the loss function is less than a threshold or meets a target requirement.

The model may also be referred to as an AI model, a rule, another name, or the like. The AI model may be considered as a specific method for implementing an AI function. The AI model represents a mapping relationship or a function between an input and an output of the model. The AI function may include one or more of data collection, model training (or model learning), model information release, model deduction (or referred to as model inference, inference, prediction, or the like), model monitoring or model verification, inference result release, or the like. The AI function may also be referred to as an AI (related) operation or an AI-related function.

The following describes an example of an implementation process of a neural network with reference to the accompanying drawings.

1. A fully-connected neural network is also referred to as a multilayer perceptron (MLP).

As shown in FIG. 2A, one MLP includes one input layer (on the left side), one output layer (on the right side), and a plurality of hidden layers (in the middle). Each layer of the MLP includes several nodes, which are referred to as neurons. Neurons at two adjacent layers are connected in pairs.

In an embodiment, in consideration of neurons at two adjacent layers, an output h of a neuron at a lower layer is obtained by using a weighted sum of all neurons x at an upper layer connected to the neuron at the lower layer and an activation function. This may be expressed as:

h=f(wx+b).

Herein, w is a weight matrix, b is a bias vector, and f is the activation function.

Further, in an embodiment, the output of the neural network may be recursively expressed as:

y=fₙ(wₙfₙ₋₁( . . . )+bₙ).

Herein, n is an index of a neural network layer, 1≤n≤N, and N is a total quantity of layers of the neural network.

In other words, the neural network may be understood as a mapping relationship from an input data set to an output data set. The neural network is usually initialized randomly, and a process of obtaining the mapping relationship from random w and b by using existing data is referred to as training of the neural network.

In an embodiment, a specific training manner is to evaluate an output result of the neural network by using a loss function.

As shown in FIG. 2B, an error may be backpropagated, and neural network parameters (including w and b) can be iteratively optimized by using a gradient descent method until the loss function reaches a minimum value, that is, “a good point (for example, an optimal point)” in FIG. 2B. It may be understood that the neural network parameter corresponding to “the good point (for example, the optimal point)” in FIG. 2B may be used as a neural network parameter in trained AI model information.

Further, in an embodiment, a gradient descent process may be expressed as:

$$θ ← θ - η \frac{\partial L}{\partial θ} .$$

Herein, θ is a to-be-optimized parameter (including w and b), L is the loss function, η is a learning rate and controls a gradient descent step, ∂ represents a derivative operation, and

$$\frac{\partial L}{\partial θ}$$

represents obtaining a derivative of θ with respect to L.

Further, in an embodiment, a backpropagation process uses a chain rule for obtaining a partial derivative.

As shown in FIG. 2C, a gradient of a parameter at a preceding layer may be obtained through recursive calculation based on a gradient of a parameter at an immediately succeeding layer. This may be expressed as:

$$\frac{\partial L}{\partial {w}_{ij}} = \frac{\partial L}{\partial {s}_{i}} \frac{\partial {s}_{i}}{\partial {w}_{ij}} .$$

Herein, wᵢⱼ is a weight of a connection between a node j and a node i, and sᵢ is an input weighted sum on the node i.

### 2. Federated Learning (FL)

A concept of the federated learning is proposed to effectively resolve difficulties faced by the current development of artificial intelligence. While fully ensuring user data privacy and security, the federated learning facilitates collaboration between various edge devices and a server at a central end to efficiently complete a learning task of a model.

As shown in FIG. 2D, an FL architecture is a most widely used training architecture in the FL field currently. A FedAvg algorithm is a basic algorithm of FL. An algorithm procedure thereof is roughly as follows.
(1) A central end initializes a to-be-trained model

$${w}_{g}^{0}$$

and broadcasts the model to all client devices.
(2) In a (t∈[1,T])^{th} round, a client k∈[1,K] performs E-epoch training on a received global model

$${w}_{g}^{t - 1}$$

based on a local data set [symbol] , to obtain a local training result

$${w}_{k}^{t} ,$$

the local training result to the central node.
(3) The central node collects and summarizes local training results from all (or some) clients. Assuming that a set of clients that upload local models in the t^{th} round is [symbol] , the central end performs weighted averaging by using quantities of samples of the corresponding clients as weights, to obtain a new global model. A specific update rule is

$${w}_{g}^{t} = {Σ}_{k ∈ {𝒮}^{t}} \frac{{D}_{k} {w}_{k}^{t}}{{Σ}_{k ∈ {𝒮}^{t}} {D}_{k}} .$$

Then, the central end broadcasts the global model

$${w}_{g}^{t}$$

the client devices for a new round of training.
(4) Steps (2) and (3) are repeated until the model converges finally or a quantity of training rounds reaches an upper limit.

In addition to the local model

$${w}_{k}^{t} ,$$

a local gradient

$${g}_{k}^{t}$$

for training may further be reported. The central node averages local gradients, and updates the global model based on a direction of an average gradient.

It can be learned that, in an FL framework, a data set exists on a distributed node. To be specific, the distributed node collects a local data set, performs local training, and reports a local result (model or gradient) obtained through training to the central node. The central node does not have a data set, is only responsible for fusing training results of distributed nodes to obtain the global model, and delivers the global model to the distributed nodes.

3. Decentralized learning: Different from the federated learning, another distributed learning architecture is decentralized learning.

As shown in FIG. 2E, a fully distributed system without a central node is considered. A design target f(x) of a decentralized learning system is usually an average value of targets fᵢ(x) of nodes, that is,

$$f ( x ) = \frac{1}{n} {Σ}_{i = 1}^{n} {f}_{i} ( x ) ,$$

where n is a quantity of distributed nodes, and x is a to-be-optimized parameter. In machine learning, x is a parameter of a machine learning (for example, a neural network) model. Each node calculates a local gradient ∇fᵢ(x) by using local data and the local target fᵢ(x), and then sends the local gradient to a neighboring node for which communication is reachable. After receiving gradient information sent by a neighboring node, any node may update a parameter x of a local model according to the following formula:

$${x}_{i}^{k + 1} = {x}_{i}^{k} - {α}_{k} ( \frac{1}{\vert {N}_{i} \vert} {Σ}_{j ∈ {N}_{i}} ∇ {f}_{j} ( {x}_{j}^{k} ) ) .$$

Herein,

$${x}_{i}^{k + 1}$$

represents a parameter of a local model obtained after a (k+1)^{th} (k is a natural number) update in an i^{th} node,

$${x}_{i}^{k}$$

represents a parameter or a local model obtained after a k^{th} update in the i^{th} node (if k is 0, it indicates that

$${x}_{i}^{k}$$

a parameter of a local model that does not participate in an update in the i^{th} node),

$${x}_{j}^{k}$$

represents a parameter of a local model obtained after a k^{th} update in a j^{th} node, αₖ represents an optimization coefficient, Nᵢ is a set of neighboring nodes of the node i, and |Nᵢ| represents a quantity of elements in the set of neighboring nodes of the node i, that is, a quantity of neighboring nodes of the node i. Through information exchange between nodes, the decentralized learning system finally learns a unified model.

A radio map can reflect a parameter value of each location point in a wireless network. Common radio maps include a channel gain map, a received signal strength map, a power spectral density map, a MCS map, and the like. Radio maps are widely used in wireless communication and networking, including network planning, interference control, power control, resource allocation, handover management, multi-hop routing, dynamic spectrum access, and cognitive radio network tasks.

The MCS map is defined as a mapping relationship between each location point in a network and an ordering of MCS indexes, and the ordering of MCS indexes reflects priorities of different MCS indexes. During MCS map construction, the MCS map may be constructed on a network side in a centralized manner. However, there may further be surplus computational capabilities in a communication network. Therefore, how to use these computational capabilities is an urgent technical problem to be resolved.

To resolve the foregoing problem, this application provides a communication method and a related device, so that computational power of a communication node can be applied to AI processing of a neural network, and flexibility of neural network deployment can be improved. Detailed descriptions are provided below with reference to the accompanying drawings.

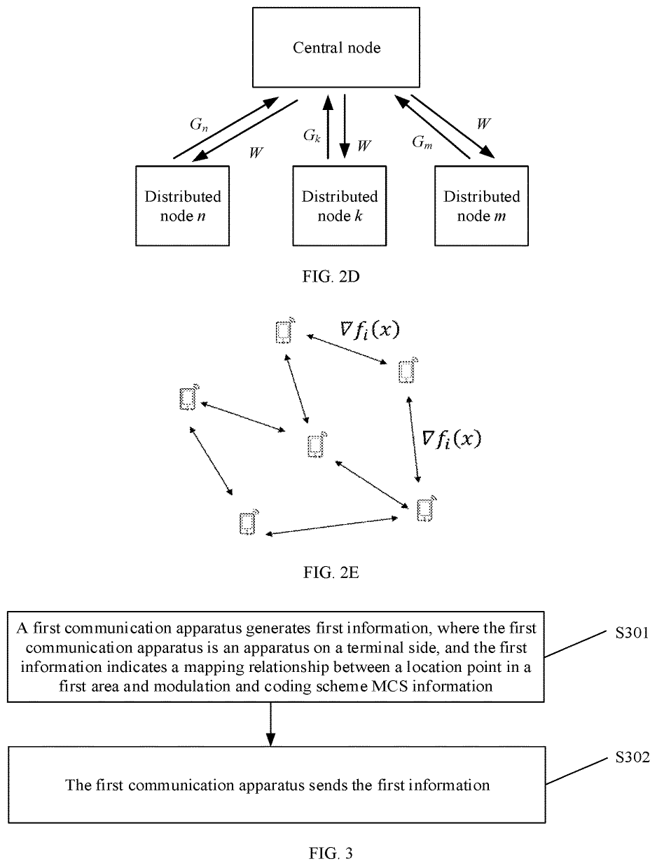

It should be noted that, in FIG. 3, the method is illustrated by using an example in which a first communication apparatus and a second communication apparatus are execution bodies of the interaction illustration. However, the execution bodies of the interaction illustration are not limited in this application. For example, in embodiments corresponding to FIG. 3 to FIG. 12, an execution body of a method may be replaced with a chip, a chip system, a processor, a logical module, software, or the like in a communication apparatus. The first communication apparatus may be an apparatus on a terminal side, the second communication apparatus may be an apparatus on a network side, and the second communication apparatus may be deployed in a multi-device distributed manner or in a centralized manner.

FIG. 3 is a diagram of an implementation of a communication method according to this application. The method includes the following steps.

S301: A first communication apparatus generates first information, where the first communication apparatus is an apparatus on a terminal side, and the first information indicates a mapping relationship between a location point in a first area and MCS information.

In a possible implementation, the first communication apparatus may perform a process of generating the first information. The first communication apparatus may be a terminal side apparatus in the first area.

The following separately describes the first area, a process of selecting the first communication apparatus, the first information, and the process of generating the first information.

With respect to the first area.

In a possible implementation, the first communication apparatus may be a terminal side apparatus in the first area. The first area may be a sub-area obtained by dividing an area served by a network device (for example, a second communication apparatus described in embodiments of this application).

During area division, a large area may be divided into a plurality of sub-areas based on, but not limited to, a geographical location, vendor information, operator information, environment information, and the like. The plurality of sub-areas may include the first area, and in an embodiment, may further include a second area described in subsequent embodiments.

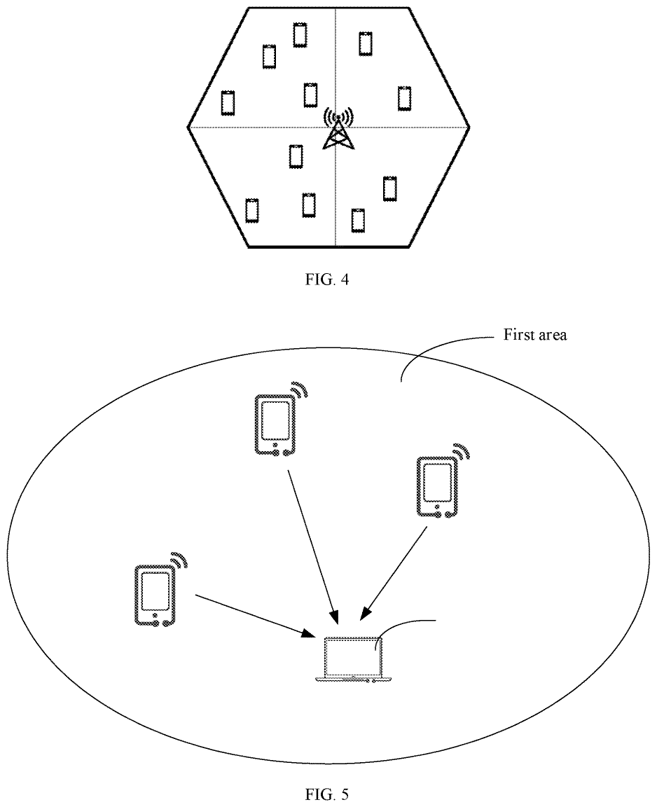

For example, the area served by the network device may be evenly divided based on the geographical location. For example, FIG. 4 is a diagram of area division. In FIG. 4, the area served by the network device is evenly divided into four sub-areas, and the first area may be one of the four sub-areas obtained through division.

For example, locations of terminal side devices manufactured by a same vendor may be used as location points in a same sub-area, and locations of terminal side devices manufactured by different vendors may be used as location points in different sub-areas, to implement area division.

For example, locations of terminal side devices of a same operator may be used as location points in a same sub-area, and locations of terminal side apparatuses of different operators may be used as location points in different sub-areas, to implement area division.

In a possible implementation, the first communication apparatus may be a terminal side apparatus configured to generate the first information in the first area.

With respect to how to select, from the first area, the terminal side apparatus configured to calculate the first information.

For the first area, one terminal side apparatus (or a plurality of distributed terminal side apparatuses) in the first area may be selected as the first communication apparatus (which may also be referred to as central user equipment) configured to generate the first information. For example, in a selection process, the network device may select, as the first communication apparatus based on computational power, a storage size, and the like of the terminal side apparatus, an apparatus that has a capability of generating the first information. After determining the apparatus configured to generate the first information, the network device may enable, by using indication information, the first communication apparatus to perceive that the first communication apparatus is an execution body for generating the first information.

It should be understood that the first communication apparatus may not be selected by the network device, but may be selected in a manner such as mutual negotiation between other devices, for example, terminal side apparatuses in the first area. This is not limited in this application.

With respect to how to generate the first information.

In a possible implementation, the first communication apparatus may obtain, based on at least information about a location point, MCS information corresponding to the location point. The location point may be a location point in a physical sense, or may be a logical or virtual location point, for example, an area set.

The information about the location point may include location information of the location point, and the location information may include but is not limited to one or more of the following information:
a. information such as coordinates and longitude and latitude of the location point; and
b. a relative location between the location point and a reference location in the first area, where the reference location may be a location of a preset apparatus on a network side, and for example, information about the relative location may include information about a direction and/or information about a distance between the network side apparatus and the location point.

The information about the direction may be described by using information about an included angle and a possible variant (for example, sine and cosine values of a value of the included angle) between the network side apparatus and the location point; and the information about the distance may be described by using the information about the distance and a possible variant (for example, a logarithmic value of the distance) between the network side apparatus and the location point.

In a possible implementation, the first communication apparatus may obtain, based on at least information about a location point and information about a network side apparatus in the first area, MCS information corresponding to the location point.

The information about the network side apparatus may include location information, network environment information, and the like of the network device. The location information may include but is not limited to one or more of the following information:
a. information such as coordinates and longitude and latitude of the network side apparatus; and
b. a relative location between the location point and a reference location in the first area, where the reference location may be a location of a preset apparatus on a network side, and for example, information about the relative location may include information about a direction and/or information about a distance between the network side apparatus and the location point.

For example, the network environment information may be described based on an environment map (for example, a satellite map or a topology map), an environment elevation map, and the like.

The information about the location point, the location information of the network device, and the network environment information of the network device may be referred to as feature information. The feature information and the corresponding location point may form a data pair. Each data pair may include one location point and feature information corresponding to the location point (for example, the information about the location point, the location information of the network device, and the network environment information of the network device described above). The data pair may be obtained by collecting information based on the terminal side apparatus.

For example, the information collected by the terminal side apparatus may be signal strength, a signal propagation direction, time, and the like, and the information collected by the terminal side apparatus may be mapped to the above-described feature information through a specific operation.

When the data pair is collected, a plurality of terminal side apparatuses in the first area may collect information at a plurality of location points, and transfer the collected information to the first communication apparatus, so that the first communication apparatus may determine second information based on the collected information, and then generate the first information based on the second information; or the first communication apparatus may move in the first area, collect information, determine second information based on the collected information, and then generate the first information based on the second information.

FIG. 5 is a schematic flowchart of obtaining, by the first communication apparatus, information collected by another terminal side apparatus at a corresponding location point. A terminal side apparatus in the first area may collect information at a location point at which the terminal side apparatus is located, and transfer the collected information to the first communication apparatus over a network. The first communication apparatus may generate the second information based on the collected information.

It should be understood that, when the foregoing plurality of groups of data pairs are collected, to enable the data pairs to reflect a network status in a relatively comprehensive manner, location points related to the plurality of groups of data pairs may cover an entire area as much as possible.

In addition, abnormal data may further be deleted (for example, a data pair whose feature is missing may be deleted) from the plurality of groups of data pairs, normalization processing may be performed on features, and the like, to obtain a plurality of groups of processed data pairs as a data basis for constructing an MCS map.

After generating the second information based on the information collected by the terminal side apparatus, the first communication apparatus may normalize feature information (for example, the information about the location point, the location information of the network device, and the network environment information of the network device) in the second information.

For example, normalization may be performed in two manners.

A first manner is intra-area normalization, which means that data in each area is normalized, and normalization parameters for different areas may be different. A second manner is global normalization. A central processing user in each area needs to upload a normalization parameter for the area to a network side device. Then, the network side device calculates a global normalization parameter (for example, an average value) and delivers the global normalization parameter to the central processing user in each area. Then, a normalization operation is completed in each area by using the same normalization parameter.

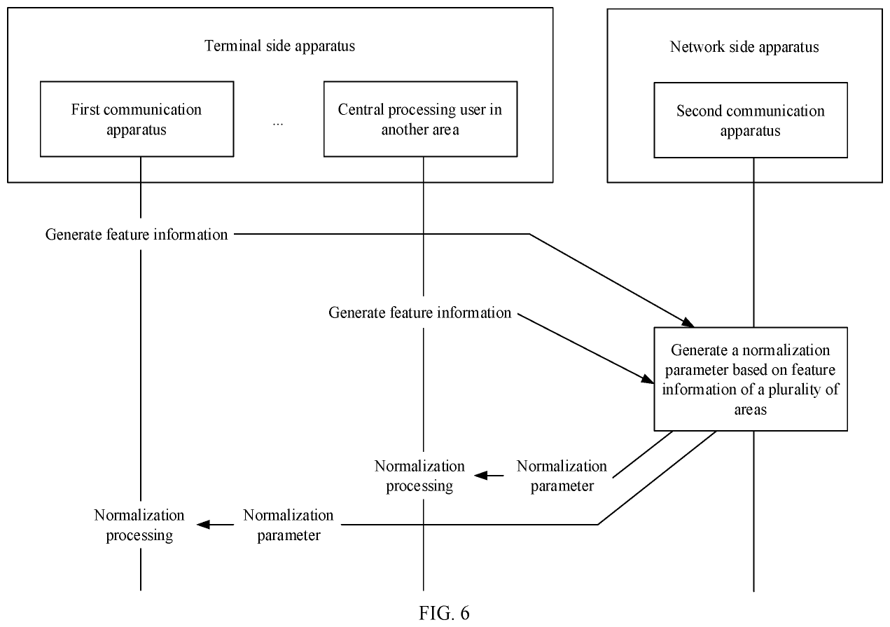

FIG. 6 is a schematic flowchart of the foregoing global normalization. The first communication apparatus serves as a central processing user in the first area, and may transfer the feature information (for example, the information about the location point, the location information of the network device, and the network environment information of the network device) in the second information to a second communication apparatus on a network side (or another network side apparatus). In addition, a central processing user in another area may also transfer feature information of a location point in the corresponding area to the second communication apparatus on the network side. The second communication apparatus on the network side may calculate a normalization parameter based on feature information in a plurality of areas (including the first area), and deliver the normalization parameter to the central processing user in each area.

After obtaining the second information (for example, the second information obtained through normalization processing), the first communication apparatus may generate the first information based on the second information. The first information is an MCS map corresponding to the first area. Further, the first information may include MCS information corresponding to a location point (for example, a plurality of location points) in the first area.

With respect to the first information.

In a possible implementation, the first information may indicate a mapping relationship between the location point in the first area and the MCS information. The first information may also be referred to as an MCS map.

A location point in the MCS map may be a location point in a physical sense, or may be a logical or virtual location point, for example, an area set. The MCS information may indicate a sorting manner of a plurality of MCS indexes, a sequence number of each MCS index describes a ranking of the corresponding MCS index in the sorting manner, and different sequence numbers correspond to different priorities.

The MCS information may directly or indirectly indicate the sorting of the MCS indexes. For example, when MCS information corresponding to each location point is generated, some intermediate results may be generated. For example, the intermediate result includes, but is not limited to, spectral efficiency or a coding rate. After the intermediate result is obtained, the intermediate result may be mapped to the MCS information.

In a possible implementation, the MCS information describes a plurality of MCS indexes arranged in a preset sequence, a sequence number of any one of the plurality of MCS indexes describes a ranking of the MCS index in the preset sequence, and different sequence numbers correspond to different priorities. In other words, the MCS information reflects respective priorities of different MCS indexes.

In this embodiment of this application, the MCS map may have a plurality of specific forms. This is not limited herein. For example, a storage form of the MCS map includes but is not limited to a graph, a list, a machine learning model, or the like.

In an embodiment, the MCS index may correspond to at least one of a modulation scheme, a coding rate (a code rate), and spectral efficiency.

There may be a plurality of manners of constructing the MCS map. This is not limited herein.

In an example, statistics may be collected on a plurality of groups of data pairs in a statistical manner, to obtain at least one piece of MCS information for each location point. MCS indexes with different sequence numbers in the MCS information may reflect different priorities. In other words, based on the plurality of groups of data pairs, in a statistical manner, an MCS index that is the most appropriate (for example, most commonly used) for each location point may be determined as an MCS index with a higher corresponding priority, and an MCS index that is not appropriate (for example, not commonly used or unavailable) for each location point may be determined as an MCS index with a lower corresponding priority.

In another example, the MCS map may be constructed based on a plurality of groups of data pairs in a machine learning manner, to learn, through machine learning, a relationship between feature information such as location information of the second communication apparatus and a probability that an MCS index is used.

When the MCS map is constructed through machine learning, a type of a used machine learning model is not limited herein.

For example, the machine learning model may be one or a combination of a CNN, a RNN, a graph neural network (GNN), or a machine learning model developed subsequently.

S302: The first communication apparatus sends the first information.

After generating the first information, the first communication apparatus may send the first information.

The first communication apparatus may send the first information carrying indication information of the first area (for example, an ID of the first area or an identifier of the first area). In other words, in addition to indicating the mapping relationship between the location point and the MCS information, the first information may also indicate a specific area to which the mapping relationship belongs.

In the foregoing manner, an execution process of constructing an MCS map (the first information) is transferred to an apparatus on the terminal side, so that computational power of a terminal side device is used, thereby reducing computational power overheads of a network device.

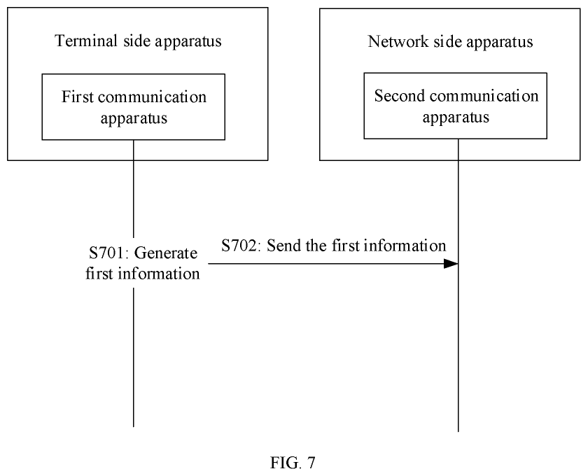

For example, in the embodiments corresponding to FIG. 7 to FIG. 11, the first communication apparatus may send the second information to the second communication apparatus on the network side. The following separately provides descriptions.

FIG. 7 is a schematic flowchart of a communication method. In comparison with the embodiment corresponding to FIG. 3, FIG. 7 details that the first information is further sent to the second communication apparatus in S302. Further, the communication method includes the following steps.

S701: A first communication apparatus generates first information, where the first communication apparatus is an apparatus on a terminal side, and the first information indicates a mapping relationship between a location point in a first area and MCS information.

S702: The first communication apparatus sends the first information to a second communication apparatus, where the second communication apparatus is an apparatus on a network side.

Correspondingly, the second communication apparatus may receive the first information, where the first information is generated by the first communication apparatus, the first communication apparatus is an apparatus on a terminal side, and the first information indicates the mapping relationship between the location point in the first area and the MCS information.

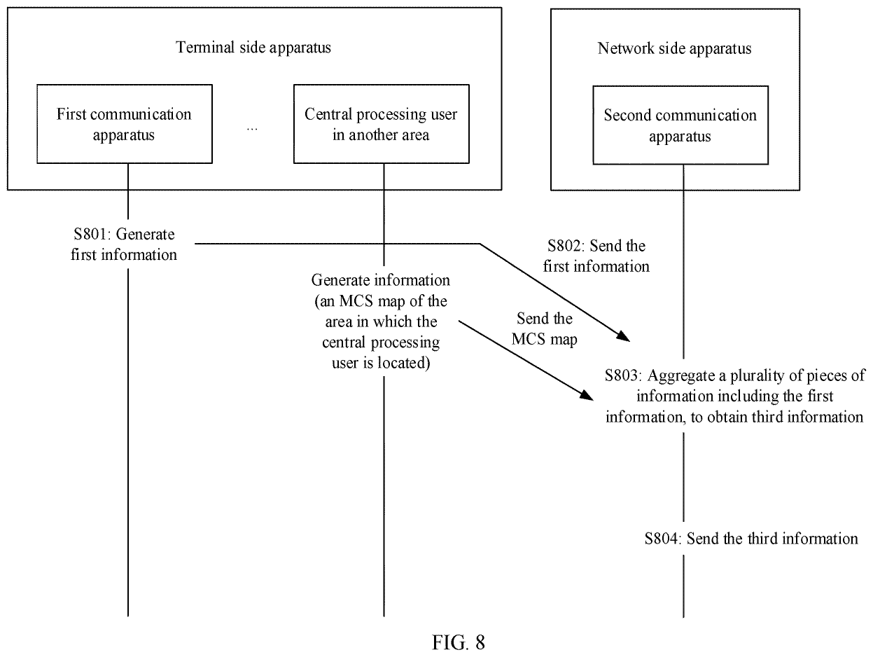

FIG. 8 is a schematic flowchart of a communication method. In comparison with the embodiment corresponding to FIG. 3, in FIG. 8, after receiving MCS maps of a plurality of areas, a second communication apparatus may aggregate the MCS maps and send an aggregation result. Further, the communication method includes the following steps.

S801: A first communication apparatus generates first information, where the first communication apparatus is an apparatus on a terminal side, and the first information indicates a mapping relationship between a location point and MCS information.

S802: The first communication apparatus sends the first information to a second communication apparatus, where the second communication apparatus is an apparatus on a network side.

S803: The second communication apparatus aggregates a plurality of pieces of information including the first information, to obtain third information.

In a possible implementation, the second communication apparatus may receive an MCS map of another area that is sent by a central processing user located in the area, and the second communication apparatus may aggregate the plurality of pieces of information including the first information, to obtain an aggregation result.

In a possible implementation, each of the plurality of pieces of information is a machine learning model, and the third information is a machine learning model obtained by fusing model processing capabilities of the plurality of pieces of information. For example, the model processing capabilities of the plurality of pieces of information may be fused in a manner such as, but not limited to, federated learning or model distillation. Fused information (that is, the third information in this embodiment of this application) may have a capability of determining corresponding MCS information based on location points in a plurality of areas (including a first area).

S804: The second communication apparatus sends the third information.

It should be understood that step S801 in which the first communication apparatus generates the first information may be a previous iterative training process of the machine learning model, and step S803 is performed after the aggregation result (that is, the third information) is obtained.

If the third information meets a training target of the model (for example, the model converges or a quantity of iterations reaches a preset value), the third information may be broadcast in a plurality of areas (or in at least the first area).

If the third information does not meet a training target of the model (for example, the model does not converge or a quantity of iterations does not reach a preset value), the third information may be delivered to a terminal side apparatus (for example, the first communication apparatus) in each area (or at least the first area). Using the first communication apparatus as an example, the first communication apparatus may further train the third information.

For example, the first communication apparatus may obtain updated information about a location point in the first area (or may obtain other updated information about the first area), and construct a training sample by using the updated information about the location point in the first area. For example, the first communication apparatus first determines corresponding MCS information based on the updated information about the location point in the first area, and uses the location point and the corresponding MCS information as a training sample to train the third information. It should be understood that the “updated information about the location point in the first area” herein may be understood as that the location point in the first area is updated, and then the information about the location point is also updated, or the location point in the first area does not change (for example, a location does not change), but the information about the location point is updated.

It should be understood that the updated information about the location point in the first area may be completely different from or partially the same as and partially different from information about the location point in the first area before the update. This is not limited herein.

According to the foregoing method, MCS maps of different areas are generated by terminal side apparatuses in the areas, and processes of generating the MCS maps of the different areas are independent of each other (or most of the processes are independent, except that there is specific coupling in terms of aggregation by a network side apparatus and determining of a normalization parameter), so that the different areas are independently calculated and more personalized. This implementation has a better effect especially when the MCS map is a machine learning model. This is because model training performed based on a training sample constructed based on information in a small area converges more easily than a model training process performed based on a training sample constructed based on information in a large area. In addition, compared with model training performed based on the training sample constructed based on the information in the large area, a manner of model training and model capability fusion based on the small area makes a fused model have a better processing capability for each area, thereby ensuring performance of the MCS map.

In addition, because a model parameter rather than information having a privacy risk, for example, information about a location point, is transmitted with the network side apparatus, a privacy leakage risk is reduced.

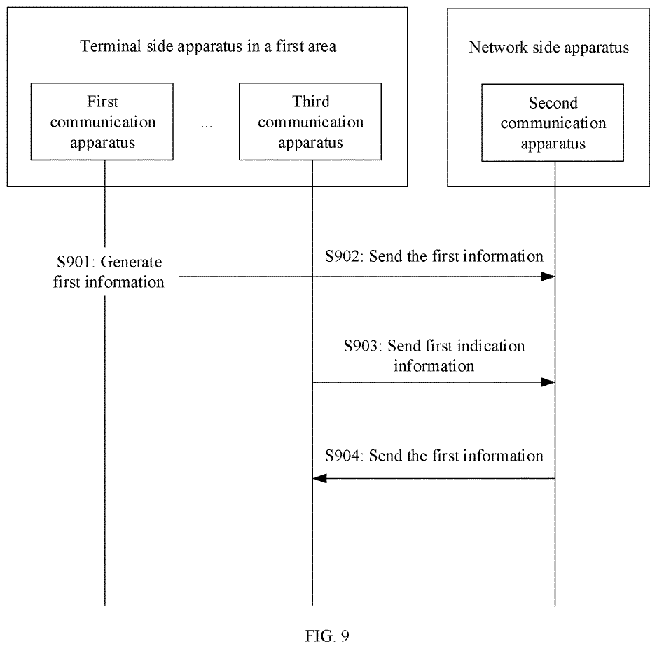

FIG. 9 is a schematic flowchart of a communication method. In comparison with the embodiment corresponding to FIG. 3, FIG. 9 describes a case that a second communication apparatus may configure an MCS map on another apparatus on a terminal side based on first information generated by a first communication apparatus. Further, the communication method includes the following steps.

S901: A first communication apparatus generates first information, where the first communication apparatus is an apparatus on a terminal side, and the first information indicates a mapping relationship between a location point and MCS information.

S902: The first communication apparatus sends the first information to a second communication apparatus, where the second communication apparatus is an apparatus on a network side.

S903: The second communication apparatus receives first indication information from a third communication apparatus, where the first indication information indicates a request for obtaining the mapping relationship between the location point in a first area and the MCS information, and the third communication apparatus is an apparatus on the terminal side.

The first indication information may also be referred to as an MCS map deployment request. The request may carry indication information of the first area.

S904: The second communication apparatus sends the first information to the third communication apparatus.

Further, the first information carrying the indication information of the first area (for example, an ID of the first area or an identifier of the first area) may be sent. In other words, in addition to indicating the mapping relationship between the location point and the MCS information, the first information may also indicate a specific area to which the mapping relationship belongs.

After obtaining the first information, the first communication apparatus may transmit information based on the first information.

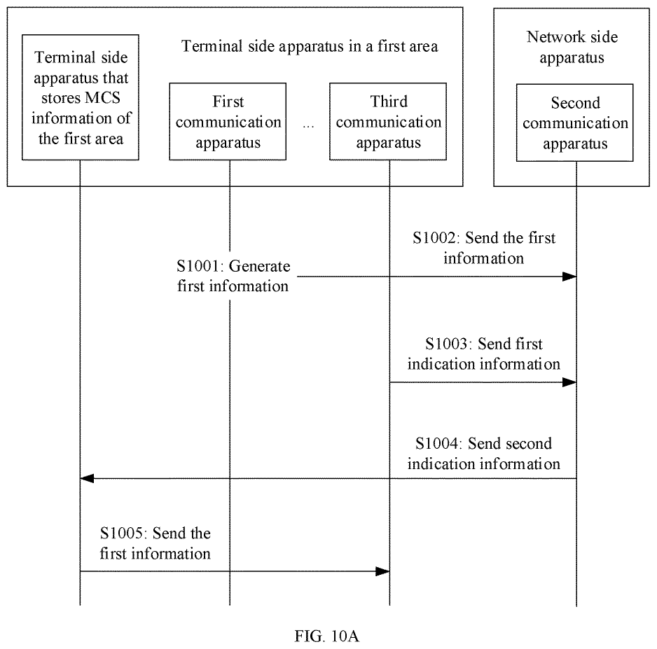

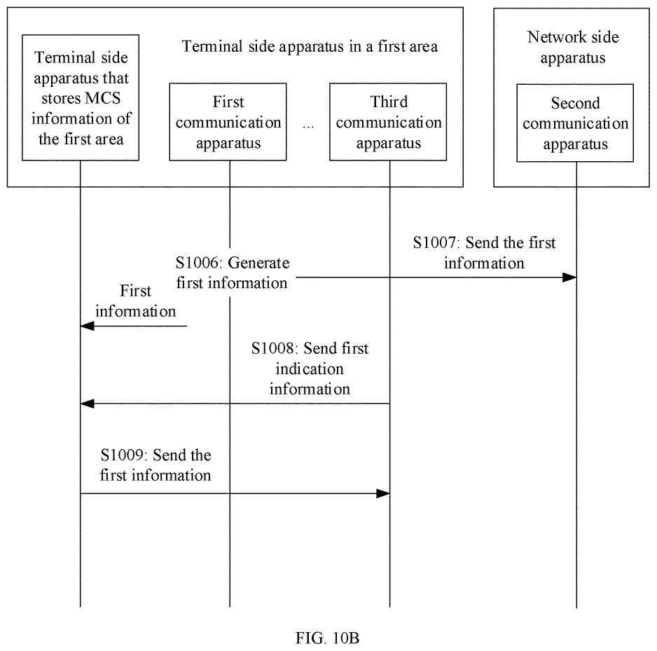

FIG. 10A is a schematic flowchart of a communication method. In comparison with the embodiment corresponding to FIG. 9, FIG. 10A describes a case that a second communication apparatus may configure an MCS map on another apparatus on a terminal side based on first information generated by a first communication apparatus, and in a configuration process, a network apparatus does not directly deliver the MCS map to the terminal side apparatus, but information is shared between terminal side apparatuses. Further, the communication method includes the following steps.

S1001: A first communication apparatus generates first information, where the first communication apparatus is an apparatus on a terminal side, and the first information indicates a mapping relationship between a location point and MCS information.

S1002: The first communication apparatus sends the first information to a second communication apparatus, where the second communication apparatus is an apparatus on a network side.

S1003: The second communication apparatus receives first indication information from a third communication apparatus, where the first indication information indicates a request for obtaining the mapping relationship between the location point in a first area and the MCS information, and the third communication apparatus is an apparatus on the terminal side.

S1004: The second communication apparatus sends second indication information to a terminal side apparatus that stores the MCS information of the first area, where the second indication information indicates to send the mapping relationship between the location point in the first area and the MCS information to the third communication apparatus.

The terminal side apparatus that stores the MCS information of the first area may be the first communication apparatus or an apparatus of a non-central processing user in the first area.

In other words, a network side apparatus may schedule users in corresponding areas to share MCS maps of the corresponding areas.

S1005: The terminal side apparatus that stores the MCS information of the first area sends the first information to the third communication apparatus.

Further, the first information carrying indication information of the first area (for example, an ID of the first area or an identifier of the first area) may be sent. In other words, in addition to indicating the mapping relationship between the location point and the MCS information, the first information may also indicate a specific area to which the mapping relationship belongs.

FIG. 10B is a schematic flowchart of a communication method. In comparison with the embodiment corresponding to FIG. 10A, FIG. 10B describes a process in which an MCS map is configured on another terminal side apparatus through information sharing between terminal side apparatuses, without a need for configuration by a network side apparatus. Further, the communication method includes the following steps.

S1006: A first communication apparatus generates first information, where the first communication apparatus is an apparatus on a terminal side, and the first information indicates a mapping relationship between a location point and MCS information.

S1007: The first communication apparatus sends the first information to a second communication apparatus, where the second communication apparatus is an apparatus on a network side.

S1008: A terminal side apparatus that stores the MCS information of a first area receives first indication information from a third communication apparatus, where the first indication information indicates a request for obtaining the mapping relationship between the location point in the first area and the MCS information, and the third communication apparatus is an apparatus on the terminal side.

The terminal side apparatus that stores the MCS information of the first area may be the first communication apparatus or an apparatus of a non-central processing user in the first area.

The first information may be deployed on another terminal side apparatus in the first area through data sharing between terminal side apparatuses in the first area.

S1009: The terminal side apparatus that stores the MCS information of the first area sends the first information to the third communication apparatus.

Further, the first information carrying indication information of the first area (for example, an ID of the first area or an identifier of the first area) may be sent. In other words, in addition to indicating the mapping relationship between the location point and the MCS information, the first information may also indicate a specific area to which the mapping relationship belongs.

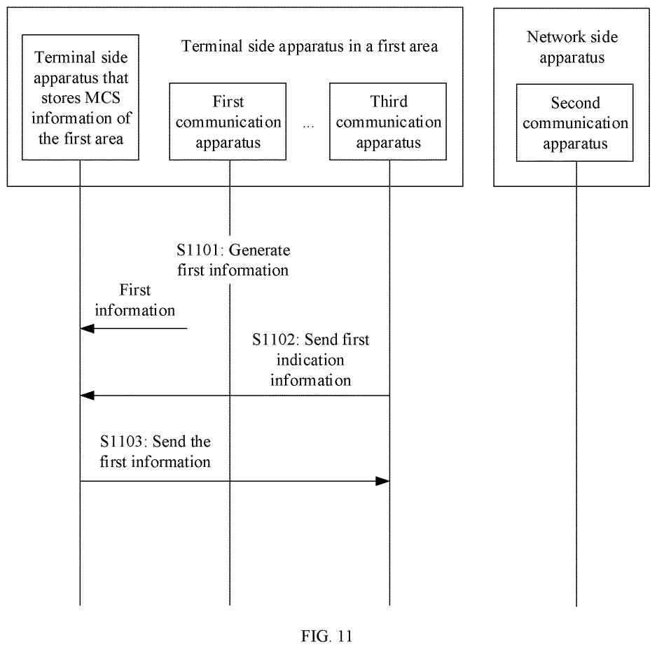

FIG. 11 is a schematic flowchart of a communication method. In comparison with the embodiment corresponding to FIG. 3, in FIG. 11, after generating first information, a first communication apparatus may not transfer the first information to a network side apparatus, and on this basis, an MCS map can still be deployed through information sharing between terminal sides. Further, the communication method includes the following steps.

S1101: A first communication apparatus generates first information, where the first communication apparatus is an apparatus on a terminal side, and the first information indicates a mapping relationship between a location point and MCS information.

The first information may be deployed on another terminal side apparatus in a first area through data sharing between terminal side apparatuses in the first area.

S1102: A third communication apparatus sends first indication information to an apparatus in the first area that stores the MCS information of the first area, where the first indication information indicates a request for obtaining the mapping relationship between the location point in the first area and the MCS information, and the third communication apparatus is an apparatus on the terminal side.

The apparatus that stores the MCS information of the first area may be the first communication apparatus or an apparatus of a non-central processing user in the first area.

S1103: The third communication apparatus receives the first information sent by the apparatus that stores the MCS information of the first area.

Further, the terminal side apparatus in the first area may send the first information carrying indication information of the first area (for example, an ID of the first area or an identifier of the first area). In other words, in addition to indicating the mapping relationship between the location point and the MCS information, the first information may also indicate a specific area to which the mapping relationship belongs.

In other words, a user side device may directly request a user in a corresponding area to share an MCS map, and the requested user shares the MCS map of the corresponding area.

Because a network side apparatus does not need to store the MCS map, storage overheads of the network side apparatus can be further reduced.

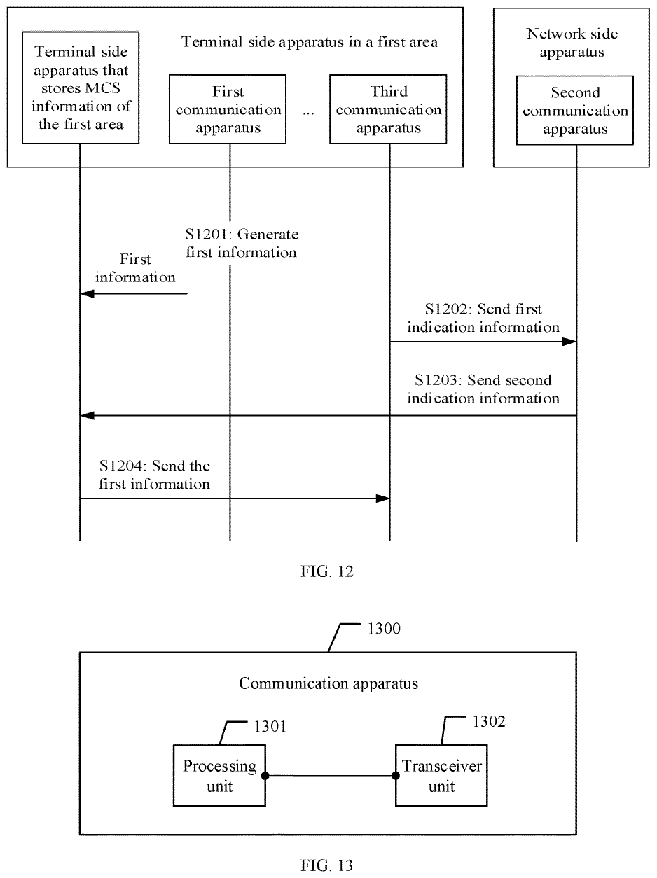

FIG. 12 is a schematic flowchart of a communication method. In comparison with the embodiment corresponding to FIG. 3, in FIG. 12, after generating first information, a first communication apparatus may not transfer the first information to a network side apparatus, and on this basis, information sharing between terminal sides can still be controlled by a network side, to deploy an MCS map. Further, the communication method includes the following steps.

S1201: A first communication apparatus generates first information, where the first communication apparatus is an apparatus on a terminal side, and the first information indicates a mapping relationship between a location point and MCS information.

The first information may be deployed on another terminal side apparatus in a first area through data sharing.

S1202: A third communication apparatus sends first indication information to a second communication apparatus, where the first indication information indicates a request for obtaining the mapping relationship between the location point in the first area and the MCS information, and the third communication apparatus is an apparatus on the terminal side.

S1203: The second communication apparatus sends second indication information to a terminal side apparatus (which, for example, may include the first communication apparatus) that stores the MCS information of the first area, where the second indication information indicates to send the mapping relationship between the location point in the first area and the MCS information to the third communication apparatus.

S1204: The third communication apparatus receives the first information sent by the terminal side apparatus in the first area.

Refer to FIG. 13. An embodiment of this application provides a communication apparatus 1300. The communication apparatus 1300 can implement a function of the second communication apparatus, the first communication apparatus, or the third communication apparatus in the foregoing method embodiments, and therefore can also achieve the beneficial effects of the foregoing method embodiments. In this embodiment of this application, the communication apparatus 1300 may be the first communication apparatus (or the second communication apparatus or the third communication apparatus), or may be an integrated circuit, an element, or the like, for example, a chip, in the first communication apparatus (or the second communication apparatus or the third communication apparatus).

It should be noted that a transceiver unit 1302 may include a sending unit and a receiving unit, which are respectively configured to perform sending and receiving.

In a possible implementation, when the apparatus 1300 is configured to perform the method performed by the first communication apparatus in the foregoing embodiments, the apparatus 1300 includes a processing unit 1301 and the transceiver unit 1302. The processing unit 1301 is configured to generate first information, where the first communication apparatus is an apparatus on a terminal side, and the first information indicates a mapping relationship between a location point in a first area and MCS information. The transceiver unit 1302 is configured to send the first information.

In a possible implementation, when the apparatus 1300 is configured to perform the method performed by the second communication apparatus in the foregoing embodiments, the apparatus 1300 includes a processing unit 1301 and the transceiver unit 1302. The transceiver unit 1302 is configured to receive first information, where the first information is generated by a first communication apparatus, the first communication apparatus is an apparatus on a terminal side, and the first information indicates a mapping relationship between a location point in a first area and MCS information.

In a possible implementation, when the apparatus 1300 is configured to perform the method performed by the third communication apparatus in the foregoing embodiments, the apparatus 1300 includes a processing unit 1301 and the transceiver unit 1302. The transceiver unit 1301 is configured to send first indication information, where the first indication information indicates a request for obtaining a mapping relationship between a location point in a first area and MCS information; and receive first information, where the first information is generated by a first communication apparatus, the first communication apparatus is an apparatus on a terminal side, and the first information indicates the mapping relationship between the location point in the first area and the MCS information.

It should be noted that, for content such as an information execution process of the units in the communication apparatus 1300, refer to the descriptions in the foregoing method embodiments of this application. Details are not described herein again.

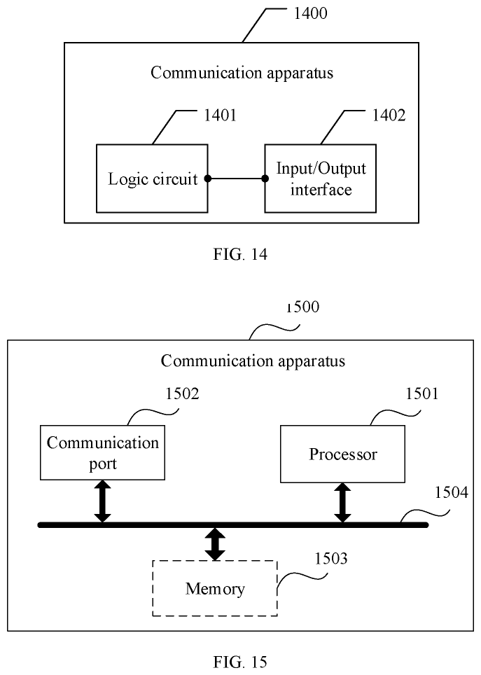

FIG. 14 is another diagram of a structure of a communication apparatus 1400 according to this application. The communication apparatus 1400 includes a logic circuit 1401 and an input/output interface 1402. The communication apparatus 1400 may be a chip or an integrated circuit.

The transceiver unit 1302 shown in FIG. 13 may be a communication interface. The communication interface may be the input/output interface 1402 in FIG. 14. The input/output interface 1402 may include an input interface and an output interface. Alternatively, the communication interface may be a transceiver circuit, and the transceiver circuit may include an input interface circuit and an output interface circuit.

In an embodiment, the input/output interface 1402 is configured to implement a function of the transceiver unit 1302 described in the foregoing embodiment, and the logic circuit 1401 is configured to implement a function of the processing unit 1301 described in the foregoing embodiment.

In an embodiment, the logic circuit 1401 may be a processing apparatus, and some or all functions of the processing apparatus may be implemented by using software. Some or all functions of the processing apparatus may be implemented by using software.

In an embodiment, the processing apparatus may include a memory and a processor.

The memory is configured to store a computer program, and the processor reads and executes the computer program stored in the memory, to perform corresponding processing and/or steps in any method embodiment.

In an embodiment, the processing apparatus may include only a processor. A memory configured to store a computer program is located outside the processing apparatus, and the processor is connected to the memory through a circuit/wire, to read and execute the computer program stored in the memory. The memory and the processor may be integrated together, or may be physically independent of each other.

In an embodiment, the processing apparatus may be one or more chips, or one or more integrated circuits. For example, the processing apparatus may be one or more field-programmable gate arrays (FPGA), application-specific integrated circuits (ASIC), systems on chip (SoC), central processing units (CPU), network processors (NP), digital signal processors (DSP), microcontroller units (MCU), programmable logic devices (PLD), or other integrated chips, or any combination of the foregoing chips or processors.

FIG. 15 shows a communication apparatus 1500 related to the foregoing embodiments according to an embodiment of this application. The communication apparatus 1500 may be further the communication apparatus serving as an apparatus on a terminal side in the foregoing embodiments. In the example shown in FIG. 15, the apparatus on the terminal side is implemented as a terminal device (or a component in a terminal device).

In a diagram of a possible logical structure of the communication apparatus 1500, the communication apparatus 1500 may include but is not limited to at least one processor 1501 and a communication port 1502.

The transceiver unit 1302 shown in FIG. 13 may be a communication interface. The communication interface may be the communication port 1502 in FIG. 15. The communication port 1502 may include an input interface and an output interface. Alternatively, the communication port 1502 may be a transceiver circuit, and the transceiver circuit may include an input interface circuit and an output interface circuit.

Further, in an embodiment, the apparatus may further include at least one of a memory 1503 and a bus 1504. In this embodiment of this application, the at least one processor 1501 is configured to control and process an action of the communication apparatus 1500.

In addition, the processor 1501 may be a central processing unit, a general-purpose processor, a digital signal processor, an application-specific integrated circuit, a field programmable gate array or another programmable logic device, a transistor logic device, a hardware component, or any combination thereof. The processor may implement or execute logical blocks, modules, and circuits in various examples described with reference to content disclosed in this application. Alternatively, the processor may be a combination of processors implementing a computing function, for example, a combination of one or more microprocessors, or a combination of a digital signal processor and a microprocessor. It may be clearly understood by a person skilled in the art that, for the purpose of convenient and brief description, for a detailed working process of the foregoing described system, apparatus, and unit, refer to a corresponding process in the foregoing method embodiment. Details are not described herein again.

It should be noted that the communication apparatus 1500 shown in FIG. 15 may be further configured to implement the steps implemented by the terminal device in the foregoing method embodiments, and achieve technical effects corresponding to the terminal device. For a specific implementation of the communication apparatus shown in FIG. 15, refer to the descriptions in the foregoing method embodiments. Details are not described herein again.

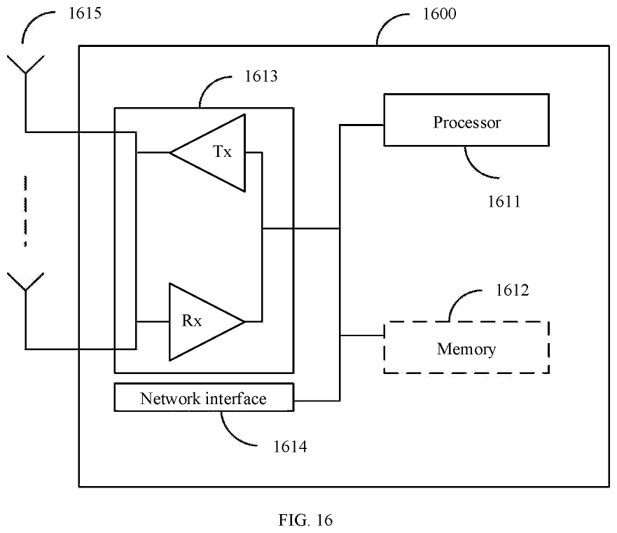

FIG. 16 is a diagram of a structure of a communication apparatus 1600 related to the foregoing embodiments according to an embodiment of this application. The communication apparatus 1600 may be further the communication apparatus serving as an apparatus on a network side in the foregoing embodiments. In the example shown in FIG. 16, the apparatus on the network side is implemented as a network device (or a component in a network device). For a structure of the communication apparatus, refer to the structure shown in FIG. 16.

The communication apparatus 1600 includes at least one processor 1611 and at least one network interface 1614. Further, in an embodiment, the communication apparatus further includes at least one memory 1612, at least one transceiver 1613, and one or more antennas 1615. The processor 1611, the memory 1612, the transceiver 1613, and the network interface 1614 are connected, for example, by using a bus. In this embodiment of this application, the connection may include various interfaces, transmission lines, buses, or the like. This is not limited in this embodiment. The antenna 1615 is connected to the transceiver 1613. The network interface 1614 is configured to enable the communication apparatus to communicate with another communication device through a communication link. For example, the network interface 1614 may include a network interface between the communication apparatus and a core network device, for example, an SI interface. The network interface may include a network interface between the communication apparatus and another communication apparatus (for example, another network device or core network device), for example, an X2 or Xn interface.

The transceiver unit 1302 shown in FIG. 13 may be a communication interface. The communication interface may be the network interface 1614 in FIG. 16. The network interface 1614 may include an input interface and an output interface. Alternatively, the network interface 1614 may be a transceiver circuit, and the transceiver circuit may include an input interface circuit and an output interface circuit.

The processor 1611 is mainly configured to process a communication protocol and communication data, control the entire communication apparatus, execute a software program, and process data of the software program, for example, configured to support the communication apparatus in performing an action described in the embodiments. The communication apparatus may include a baseband processor and a central processing unit. The baseband processor is mainly configured to process the communication protocol and the communication data. The central processing unit is mainly configured to control the entire terminal device, execute the software program, and process the data of the software program. The processor 1611 in FIG. 16 may integrate functions of the baseband processor and the central processing unit. A person skilled in the art may understand that the baseband processor and the central processing unit may alternatively be independent processors, and are interconnected by using a technology such as a bus. A person skilled in the art may understand that the terminal device may include a plurality of baseband processors to adapt to different network standards, the terminal device may include a plurality of central processing units to enhance processing capabilities of the terminal device, and components of the terminal device may be connected by using various buses. The baseband processor may also be expressed as a baseband processing circuit or a baseband processing chip. The central processing unit may also be expressed as a central processing circuit or a central processing chip. A function of processing the communication protocol and the communication data may be built in the processor, or may be stored in the memory in a form of a software program, and the processor executes the software program to implement a baseband processing function.

The memory is mainly configured to store the software program and data. The memory 1612 may exist independently, and is connected to the processor 1611. In an embodiment, the memory 1612 and the processor 1611 may be integrated together, for example, integrated into one chip. The memory 1612 can store program code for performing the technical solutions in embodiments of this application, and execution is controlled by the processor 1611. Various types of executed computer program code may also be considered as a driver of the processor 1611.

FIG. 16 shows only one memory and one processor. In an actual terminal device, there may be a plurality of processors and a plurality of memories. The memory may also be referred to as a storage medium, a storage device, or the like. The memory may be a storage element on a same chip as the processor, that is, an on-chip storage element, or may be an independent storage element. This is not limited in this embodiment of this application.

The transceiver 1613 may be configured to support receiving or sending of a radio frequency signal between the communication apparatus and a terminal, and the transceiver 1613 may be connected to the antenna 1615. The transceiver 1613 includes a transmitter Tx and a receiver Rx. Further, the one or more antennas 1615 may receive a radio frequency signal, and the receiver Rx of the transceiver 1613 is configured to receive the radio frequency signal from the antenna, convert the radio frequency signal into a digital baseband signal or a digital medium-frequency signal, and provide the digital baseband signal or the digital medium-frequency signal to the processor 1611, so that the processor 1611 performs further processing, for example, demodulation processing and decoding processing, on the digital baseband signal or the digital medium-frequency signal. In addition, the transmitter Tx in the transceiver 1613 is further configured to receive a modulated digital baseband signal or digital medium-frequency signal from the processor 1611, convert the modulated digital baseband signal or digital medium-frequency signal into a radio frequency signal, and send the radio frequency signal by using the one or more antennas 1615. Further, the receiver Rx may selectively perform one or more levels of down-mixing processing and analog-to-digital conversion processing on the radio frequency signal to obtain the digital baseband signal or the digital medium-frequency signal. A sequence of the down-mixing processing and the analog-to-digital conversion processing is adjustable. The transmitter Tx may selectively perform one or more levels of up-mixing processing and digital-to-analog conversion processing on the modulated digital baseband signal or digital medium-frequency signal to obtain the radio frequency signal. A sequence of the up-mixing processing and the digital-to-analog conversion processing is adjustable. The digital baseband signal and the digital medium-frequency signal may be collectively referred to as a digital signal.

The transceiver 1613 may also be referred to as a transceiver unit, a transceiver machine, a transceiver apparatus, or the like. In an embodiment, a component configured to implement a receiving function in the transceiver unit may be considered as a receiving unit, and a component configured to implement a sending function in the transceiver unit may be considered as a sending unit. In other words, the transceiver unit includes a receiving unit and a sending unit. The receiving unit may also be referred to as a receiver, an input port, a receiving circuit, or the like. The sending unit may be referred to as a transmitter machine, a transmitter, a transmission circuit, or the like.

It should be noted that the communication apparatus 1600 shown in FIG. 16 may be further configured to implement the steps implemented by the network device in the foregoing method embodiments, and achieve technical effects corresponding to the network device. For a specific implementation of the communication apparatus 1600 shown in FIG. 16, refer to the descriptions in the foregoing method embodiments. Details are not described herein again.

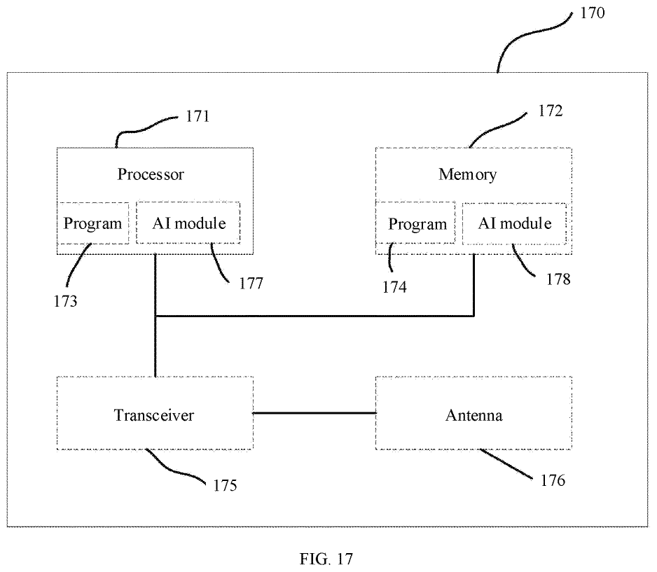

FIG. 17 is a diagram of a structure of a communication apparatus related to the foregoing embodiments according to an embodiment of this application.

It may be understood that the communication apparatus 170 includes, for example, modules, units, elements, circuits, or interfaces, which are appropriately configured together to perform the technical solutions provided in this application. The communication apparatus 170 may be the terminal device or the network device described above, or may be a component (for example, a chip) in these devices, to implement the method described in the following method embodiments. The communication apparatus 170 includes one or more processors 171. The processor 171 may be a general-purpose processor, a dedicated processor, or the like. For example, the processor may be a baseband processor or a central processing unit. The baseband processor may be configured to process a communication protocol and communication data. The central processing unit may be configured to control the communication apparatus (for example, a RAN node, a terminal, or a chip), execute a software program, and process data of the software program.

In an embodiment, in a design, the processor 171 may include a program 173 (which may also be referred to as code or instructions sometimes). The program 173 may be run on the processor 171, to enable the communication apparatus 170 to perform the method described in the following embodiments. In another possible design, the communication apparatus 170 includes a circuit (not shown in FIG. 17).

In an embodiment, the communication apparatus 170 may include one or more memories 172 storing a program 174 (which may also be referred to as code or instructions sometimes). The program 174 may be run on the processor 171, to enable the communication apparatus 170 to perform the method described in the foregoing method embodiments.

In an embodiment, the processor 171 and/or the memory 172 may include AI modules 177 and 178, and the AI module is configured to implement an AI-related function. The AI module may be implemented by using software, hardware, or a combination of software and hardware. For example, the AI module may include a radio intelligence control (RIC) module. For example, the AI module may be a near-real-time RIC or a non-real-time RIC.

In an embodiment, the processor 171 and/or the memory 172 may further store data. The processor and the memory may be separately disposed, or may be integrated together.

In an embodiment, the communication apparatus 170 may further include a transceiver 175 and/or an antenna 176. The processor 171 may also be referred to as a processing unit sometimes, and control the communication apparatus (for example, a RAN node or a terminal). The transceiver 175 may also be referred to as a transceiver unit, a transceiver machine, a transceiver circuit, a transceiver, or the like sometimes, and is configured to implement receiving and sending functions of the communication apparatus through the antenna 176.

The processing unit 1301 shown in FIG. 13 may be the processor 171. The transceiver unit 1302 shown in FIG. 13 may be a communication interface. The communication interface may be the transceiver 175 in FIG. 17. The transceiver 175 may include an input interface and an output interface. Alternatively, the transceiver 115 may be a transceiver circuit, and the transceiver circuit may include an input interface circuit and an output interface circuit.

An embodiment of this application further provides a computer-readable storage medium. The storage medium is configured to store one or more computer-executable instructions. When the computer-executable instructions are executed by a processor, the processor performs the method according to the possible implementations of the first communication apparatus, the second communication apparatus, or the third communication apparatus in the foregoing embodiments.

An embodiment of this application further provides a computer program product (or referred to as a computer program). When the computer program product is executed by the processor, the processor performs the method according to the possible implementations of the first communication apparatus, the second communication apparatus, or the third communication apparatus.

An embodiment of this application further provides a chip system. The chip system includes at least one processor configured to support a communication apparatus in implementing the functions in the foregoing possible implementations of the communication apparatus. In an embodiment, the chip system further includes an interface circuit, and the interface circuit provides program instructions and/or data for the at least one processor. In a possible design, the chip system may further include a memory. The memory is configured to store program instructions and data that are necessary for the communication apparatus. The chip system may include a chip, or may include a chip and another discrete component. The communication apparatus may be further the first communication apparatus, the second communication apparatus, or the third communication apparatus in the foregoing method embodiments.

An embodiment of this application further provides a communication system. The network system architecture includes the first communication apparatus and the second communication apparatus, or the first communication apparatus and the third communication apparatus, or the second communication apparatus and the third communication apparatus in any one of the foregoing embodiments.

In the several embodiments provided in this application, it should be understood that the disclosed system, apparatus, and method may be implemented in other manners. For example, the described apparatus embodiments are merely examples. For example, division into the units is merely logical function division. In actual implementation, there may be another division manner. For example, a plurality of units or components may be combined or integrated into another system, or some features may be ignored or not performed. In addition, the displayed or discussed mutual couplings or direct couplings or communication connections may be implemented through some interfaces, and indirect couplings or communication connections between apparatuses or units may be implemented in an electrical, mechanical, or another form.

The units described as separate parts may or may not be physically separate, and parts displayed as units may or may not be physical units, may be located in one place, or may be distributed on a plurality of network units. Some or all of the units may be selected according to an actual requirement to achieve the objectives of the solutions in the embodiments.

In addition, functional units in embodiments of this application may be integrated into one processing unit, or each unit may exist alone physically, or two or more units may be integrated into one unit. The integrated unit may be implemented in a form of hardware, or may be implemented in a form of a software functional unit. When the integrated unit is implemented in a form of a software functional unit and sold or used as an independent product, the integrated unit may be stored in a computer-readable storage medium. Based on such an understanding, the technical solutions of this application essentially, or the contributing part, or all or some of the technical solutions may be implemented in a form of a software product. The computer software product is stored in a storage medium and includes several instructions for instructing a computer device (which may be a personal computer, a server, or a network device) to perform all or some of the steps of the methods described in embodiments of this application. The foregoing storage medium includes any medium that can store program code, such as a Universal Serial Bus (USB) flash drive, a removable hard disk, a read-only memory (ROM), a random-access memory (RAM), a magnetic disk, or an optical disc.

1. A method, comprising:
generating, by a first communication apparatus on a terminal side, first information indicating a mapping relationship between a location point in a first area and modulation and coding scheme (MCS) information; and
sending the first information.

2. The method of claim 1, wherein generating the first information comprises generating the first information based on second information indicating the location point.

3. The method of claim 1, wherein the MCS information indicates an ordering manner of MCS indexes.

4. The method of claim 1, wherein the first communication apparatus communicates with a second communication apparatus on a network side, and wherein the first area is a part of a target area of the second communication apparatus.

5. The method of claim 2, wherein the second information is based on third information collected at the location point by the first communication apparatus or by at least one user side apparatus in the first area.

6. The method of claim 1, wherein the first information further indicates the first area.

7. The method of claim 2, further comprising:
obtaining a normalization parameter based on third information collected at the location point in the first area; and
normalizing the second information based on the normalization parameter.

8. The method of claim 2, further comprising:
obtaining a normalization parameter based on third information collected at location points in a plurality of areas comprising the first area; and
normalizing the second information based on the normalization parameter.

9. A method comprising:
sending first indication information requesting a mapping relationship between a location point in a first area and modulation and coding scheme (MCS) information; and
receiving from a first communication apparatus on a terminal side, first information indicating the mapping relationship.

10. The method of claim 9, wherein sending the first indication information comprises sending the first indication information to a second communication apparatus on a network side, and wherein receiving the first information comprises receiving the first information from the first communication apparatus in the first area.

11. The method of claim 9, wherein sending the first indication information comprises sending the first indication information to the first communication apparatus in the first area, and wherein receiving the first information comprises receiving the first information from the first communication apparatus in the first area.

12. The method of claim 9, wherein sending the first indication information sending the first indication information to a second communication apparatus on a network side, and wherein receiving the first information comprises receiving the first information from the second communication apparatus.

13. A communication apparatus, comprising:
one or more memories configured to store instructions, and
one or more processors coupled to the one or more memories, wherein when executed by the one or more processor instructions cause the communication apparatus to:
generate first information indicating a mapping relationship between a location point in a first area and modulation and coding scheme (MCS) information; and
send the first information.

14. The communication apparatus of claim 13, wherein when executed by the one or more processors, the instructions further cause the communication apparatus to further generate the first information based on second information indicating the location point.

15. The communication apparatus of claim 13, wherein the MCS information indicates an ordering manner of MCS indexes.

16. The communication apparatus of claim 13, wherein the communication apparatus communicates with a second communication apparatus on a network side, and wherein the first area is a part of a target area of the second communication apparatus.

17. The communication apparatus of claim 14, wherein the second information based on third information collected at the location point by the communication apparatus or by at least one user side apparatus in the first area.

18. The communication apparatus of claim 13, wherein the first information further indicates the first area.

19. The communication apparatus of claim 14, wherein when executed by the one or more processors, the instructions further cause the communication apparatus to:
obtain a normalization parameter based on third information collected at the location point in the first area; and
normalize the second information based on the normalization parameter.

20. The communication apparatus of claim 14, wherein when executed by the one or more processors, the instructions further cause the communication apparatus to:
obtain a normalization parameter based on third information collected at location points in a plurality of areas comprising the first area; and
normalize the second information based on the normalization parameter.
